(19) United States
(12) Patent Application Publication
(10) Pub. No.: US 2009/0173693 A1
(43) Pub. Date: Jul. 9, 2009

(54) LYOTROPIC LIQUID CRYSTAL MEMBRANES BASED ON CROSS-LINKED TYPE I BICONTINUOUS CUBIC PHASES

(76) Inventors: Douglas L. Gin, Longmont, CO (US); Meijuan Zhou, Los Angeles, CA (US); Richard D. Noble, Boulder, CO (US); Jason E. Bara, Boulder, CO (US); Robert L. Kerr, Longmont, CO (US); Brian R. Wiesenauer, Boulder, CO (US)

Correspondence Address: GREENLEE WINNER AND SULLIVAN P C, 4875 PEARL EAST CIRCLE, SUITE 200, BOULDER, CO, 80301, US

(21) Appl. No.: 12/121,617

(22) Filed: May 15, 2008

Related U.S. Application Data
(60) Provisional application No. 60/938,126, filed on May 15, 2007.

(51) Int. Cl. B01D 71/06; B01D 67/00; B01D 61/14

(52) U.S. Cl. 210/650; 210/490

(57) ABSTRACT

The invention provides composite nanofiltration membranes with a lyotropic liquid crystal (LLC) polymer composition embedded in or forming a layer on a porous support. The LLC membranes are prepared from LLC monomers which form a bicontinuous cubic (Q_{I}) phase. The arrangement, size, and chemical properties of the pores can be tailored on the molecular level. The composite membranes of the invention are useful for separation processes involving aqueous and nonaqueous solutions as well as gases. Methods for making and using the composite nanofiltration membranes of the invention are also provided.

### CROSS REFERENCE TO RELATED APPLICATIONS

This application claims the benefit of U.S. provisional application 60/938,126, filed May 15, 2007; all applications to which priority is claimed are hereby incorporated by reference to the extent not inconsistent with the disclosure herein.

### ACKNOWLEDGEMENT OF GOVERNMENT SUPPORT

This invention was made at least in part with support from the United States Government under support from the Office of Naval Research (under Grant Nos. N00014-02-0383, N00014-03-1-0993 and N00014-05-0038), and from the National Science Foundation (under Grant No. DMR-0552399). The United States Government has certain rights in this invention.

### BACKGROUND OF THE INVENTION

This invention is in the field of composite membranes, in particular porous composite membranes employing a porous lyotropic liquid crystal (LLC) polymer composition embedded within or on top of a porous support membrane, the LLC polymer composition having a pore structure of interconnected nanopores. The composite membranes of the invention can be used for water desalination and nanofiltration.

The production of pure water from seawater or brackish water is extremely important in regions and situations where clean water supplies are unavailable. Reverse osmosis (RO) is a membrane process that removes hydrated salt ions (<1 nm in diameter) and larger solutes from water, irrespective of their charge (Fell, C. J. D. “Reverse Osmosis,” In Membrane Separations Technology. Principles and Applications; Noble, R. D.; Stern, A. S.; Eds.; Elsevier Science: Amsterdam, 1995; Chapter 4; and references therein). RO membranes typically consist of a dense, amorphous, ultrathin (≦0.1 μm) polymer active layer (cellulose acetate (Fell, 1995), poly(aryl amide)s (Fell, 1995), or sulfonated polymers (Ventoza, T. P.; Lloyd, D. R. Desalination 1985, 56, 381)) on top of a porous support. It is believed that in RO membranes, hydrated salt ions (e.g., Na⁺_{(aq)}:0.72 nm diameter) (Nightingale, Jr., E. R. J. Phys. Chem. 1959, 63, 1381) are “size-excluded” through the ≦0.5 nm interstitial voids between the polymer chains, while smaller water molecules (0.25 nm) are able to pass through (Fell, 1995). Nanofiltration (NF) membranes are similar to RO membranes, but the polymer active layer is porous (i.e., contains discrete nanometer-size pores) and usually charged (Bhattacharya, A.; Ghosh, P. Rev. Chem. Eng. 2004, 20, 111). NF membranes can completely reject molecular solutes 1-10 nm in diameter via size- and charge-based exclusion but only partially reject small monovalent ions (Bhattacharya, 2004). Current RO and NF membrane production methods (e.g., interfacial polymerization) provide little control over the size and distribution of the interstitial voids or nanopores (Fell, 1995; Bhattacharya, 2004). Several polymer synthesis and modification strategies have recently been explored that generate membranes with nanopores for liquid filtration. These include thermotropic LC templating and polymerization (Gankema, H.; Hempenius, M. A.; Möller, M.; Johansson, G.; Percec, V. Macromol. Symp. 1996, 102, 381; Beginn, U.; Zipp, G.; Mourran, A.; Walther, P.; Möller, M. Adv. Mater. 2000, 12, 513), selectively etched phase-separated block copolymers (Liu, G.; Ding, J. Adv. Mater. 1998, 10, 69; Wolf, J. H.; Hillmyer, M. A. Langmuir 2003, 19, 6553; Yang, S. Y.; Ryu, I.; Kim, H. Y.; Kim, J. K.; Jang, S. K.; Russell, T. P. Adv. Mater. 2006, 18, 70), use of molecular squares (Czaplewski, K. F.; Hupp, J. T.; Snurr, R. Q. Adv. Mater. 2001, 13, 1895), electrochemical pore reduction of track-etch membranes (Jirage, K. B.; Hulteen, J. C.; Martin, C. R. Science 1997, 278, 655) and coating with amphiphilic graft copolymers: Akthuakul, A.; Salinara, R. F.; Mayes, A. M. Macromolecules 2004, 37, 7663) Only one of these methods affords pores smaller than 1 nm (Jirage, 1997); and none have been reported to be able to perform water desalination. Jirage et al. (1997) report molecular-size selective nanofiltration in the approximately 1 nm size range; because of the relatively low pore density (<10% surface coverage), the water fluxes and permeabilities were also relatively low.

Polymer membranes based on lyotropic liquid crystal (LLC) mesogens are of interest because of the ability of LLC mesogens to self-assemble into ordered, nanoporous aggregate structures in the presence of a solvent such as water. The aggregates can be relatively highly ordered yet fluid condensed assemblies with specific nanometer-scale geometries, known collectively as LLC phases (Gin et. al., “Polymerized Lyotropic Liquid Crystal Assemblies for Materials Applications,” 2001, Acc. Chem. Rec. 24, 973-980). LLC mesogens are amphiphilic molecules containing one or more hydrophobic organic tails and a hydrophilic headgroup. Surfactants can be classified as amphiphiles (D. Considine, ed., Van Nostrand's Scientific Encyclopedia, Seventh Edition, 1989, Van Nostrand Reinhold, New York, p. 861).

Polymer membranes based on related work with polymerized thermotropic (i.e., thermal and shape-based self-organization vs. water based LLC self-organization) LC mesogens have been reported. Beginn et al. reported membranes containing ion-selective, matrix-fixed, supramolecular channels (Beginn, U.; Zipp, G.; Möller, M. “Functional Membranes Containing Ion-Selective Matrix Fixed Supramolecular Channels,” Adv. Mater. 2000, 12, 510). Solutions of 2-hydroxymethyl-[1,4,7,10,13-pentaoxacyclopentadecane]-3,4,5-tris[4-(11-methacryloylundecyl-1-oxy)benzyloxy]benzoate, a tris-methacrylated crown ether amphiphile, in a mixture of monomers, cross-linkers, and a photo-initiator were reportedly cast to thin films on a supporting porous filter (Pall Filtron NOVA membrane with maximum pore size of 10 microns). The mixture was subsequently cooled to −50° C. on a temperature-controlled aluminum block and then polymerized. The cross-section of the supported membrane reportedly showed that the support was completely filled with the cross-linked methacrylate. The supramolecular channels were reportedly formed by self-assembly of the tris-methacrylated crown ether amphiphile into long cylindrical aggregates with the crown ether moieties stacked parallel to the column axis and the polymerizable groups forming the shell of the cylinder.

Beginn et al. also reported ion-conducting, polymerized LC membranes containing oriented supramolecular transport channels (Beginn, U.; Zipp, G.; Mourran, A., Walther, P., and Möller, M. “Membranes Containing Oriented Supramolecular Transport Channels,” Adv. Mater. 2000, 12, 513-516.). The membranes were synthesized by filling the 400 nm wide pores of a track-etched polyester membrane with a hot isotropic methacrylate solution of 2-hydroxymethyl-[1,4,7,10,13-pentaoxacyclopentadecane]-3,4,5-tris[4-(11-meth acryloylundecyl-1-oxy)benzyloxy]benzoate, a tris-methacrylated crown ether amphiphile (60 wt.-%). The filled polyester membrane was cooled below the isotropization temperature of the lyotropic solution and the solution polymerized.

WO 98/30318 to Gin et al. states that polymer membranes can be formed from amphiphilic LLC monomers that will self-organize into stable, inverse hexagonal phases in the presence of pure water or other hydrophilic solutions. It was further stated that in situ photopolymerization of the hydrophobic tails into a heavily cross-linked network with retention of the template microstructure yields a robust polymer network with highly uniform pores arranged in a regular hexagonal array. Formation of a polymer film between two glass slides by photopolymerization of a LLC monomer mixture was reported. It was further reported that the film could be peeled off the glass slides in one piece.

WO 2004/060531 to Gin et al. reports composite membranes comprising a porous support and a lyotropic liquid crystal polymer porous membrane attached to the support and methods for making such membranes.

U.S. Pat. No. 5,238,613 to Anderson reports polymeric membrane materials having a pore size between two nanometers and sixty microns. The porosity of the membrane materials is reported to be greater than fifty percent. U.S. Pat. No. 5,238,613 reports a method for forming a microporous membrane materials involving polymerization of the hydrophobic component in a ternary surfactant/water/hydrophobe cubic phase. U.S. Pat. No. 5,238,613 also states that binary water/polymerizable phases could provide a route for membrane formation.

A need continues to exist for polymer membrane manufacturing technologies which allow control of critical structural features such as pore size, pore architecture, and pore density in the nanometer and sub-1-nanometer size regimes. A need also exists for polymer membranes for which these critical structural features can be controlled on this extremely important size scale. By having polymer materials with pores on the ca. 1 nm size scale, it is possible to separate molecules discretely based on the differences in their intrinsic sizes. By having polymer membranes with controlled pores that are <1 nm in size, it is possible to cleanly separate even smaller chemical species such as hydrated ions from small water molecules (desalination).

### SUMMARY OF THE INVENTION

In an embodiment, the invention provides a composite membrane comprising: a porous support; and a porous lyotropic liquid crystal (LLC) polymer composition attached to the support, the LLC polymer composition having a pore structure of interconnected nanopores based on the type I (normal type ) bicontinuous cubic (Q_{I}) LLC phase structure. In an embodiment, the LLC polymer composition comprises a polymer network formed from polymerizable LLC monomers and optional cross-linking agents. In different embodiments the effective pore size of the polymer composition is 0.5-5 nm, greater than or equal to 0.5 to less than 2 nm, or from 0.5 to 1 nm. In an embodiment, the LLC polymer composition is at least partially embedded within the porous support. In another embodiment, the LLC polymer composition is formed in situ as a coating on at least a part of the surface of the porous support.

In an embodiment, the present invention creates nanostructured porous composite membranes in which the arrangement, size, and chemical properties of the pores may be tailored on the molecular level by using polymerizable lyotropic (i.e., amphiphilic) liquid crystals (LLCs) as building blocks. These composite membranes can act as novel nanoporous membranes capable of selectively removing nanometer-size impurities, organic molecules, certain ions, and other contaminants from solutions based solely on molecular size. In addition, the incorporation of chemical complexing agents in the nanopores of these materials can enable other forms of separation processes.

In an embodiment, the invention provides a composite nanofiltration membrane comprising: a porous support and a porous lyotropic liquid crystal (LLC) polymer composition attached to the support, the LLC polymer composition formed by polymerization of an LLC mixture which forms the type I (normal type ) bicontinuous cubic LLC phase, the LLC mixture comprising polymerizable LLC monomers and a solvent and not including a hydrophobic polymer, the LLC polymer composition comprising a pore structure of interconnected nanopores based on the type I bicontinuous cubic LLC structure. The polymerizable LLC monomers are assembled in the type I (normal type) bicontinuous phase prior to polymerization.

In an embodiment, the pores of the LLC polymer composition may be filled with water or an aqueous solution. The membranes of the invention are believed to provide a unique alternative to biological membranes with water filled nanometer sized pores.

The composite membranes of the invention are useful for separation processes involving aqueous and nonaqueous solutions as well as gases. In an embodiment, the membranes of the invention are suitable for filtration of aqueous solutions. For example, the composite membranes of the invention can be useful for water desalination, allowing rejection of 94% or more of dissolved salts such as NaCl, MgCl₂, and CaCl₂. The composite membranes of the invention are also useful for nanofiltration of neutral molecules and macromolecules and molecular ions in the 0.64-1.2 nm size range. The composite membrane can also be made in flexible form, which allows it to be used in a variety of membrane configurations (e.g., spiral-wound).

In an embodiment, the invention also provides methods for making nanofiltration membranes which can be simpler than that for making currently available nanofiltration membranes. In an embodiment, the invention provides a method for making a composite membrane comprising the steps of: providing a porous support, preparing a LLC mixture comprising a plurality of LLC monomers, a polymerization initiator and an aqueous or polar organic solvent and not including a separate hydrophobic polymer, wherein at least some of the LLC monomers assemble to form a normal (Type I) bicontinuous cubic (i.e., a Q_{I}) LLC phase; impregnating the porous support with the LLC mixture; and cross-linking the LLC monomer. In another embodiment, the invention provides a method for making a composite membrane comprising the steps of: providing a porous support, preparing a LLC mixture comprising a plurality of LLC monomers, a polymerization initiator and an aqueous or polar organic solvent and not including a separate hydrophobic polymer, wherein at least some of the LLC monomers assemble to form a Q_{I} LLC phase; applying a layer of the LLC mixture to the support; and cross-linking the LLC monomer. In both embodiments, the Q_{I} LLC phase is substantially maintained during impregnation/application and cross-linking. In an embodiment, the desired bicontinuous cubic phase is maintained through control of solvent (e.g., water) content and temperature of the LLC mixture.

### BRIEF DESCRIPTION OF THE FIGURES

FIG. 1 illustrates bicontinuous cubic (Q_{I}) LLC phases, the proposed mechanism of water desalination and nanofiltration through a Q_{I} material, and an X-ray diffraction profile and photograph (grid 0.25×0.25 inch) of a supported Q_{I} material

FIG. 2 Preparation of supported, cross-linked Q_{I}-phase LLC membranes of monomer 1 (y=6, x=10) on Solupor® E075-9H01A support via hot-pressing and free radical photopolymerization at elevated temperatures. (Each grid square in the photo above is 0.25×0.25 inches in size.)

FIG. 3. XRD profiles of (a) a photo-cross-linked supported Q_{I} membrane of monomer 1 (y=6, x=10) on Solupor® (E075-9H01A; (b) a piece of blank Solupor® E075-9H01A support; (c) a free-standing Q_{I}-phase film of monomer 1; and (d) the supported Q_{I} membrane after subtraction of the baseline XRD spectrum of the blank Solupor® E075-9H01A support film. A digital picture of the supported Q_{I} membrane is shown in the inset (scale: 1 grid square=0.25×0.25 inches).

FIG. 4. Schematic representation of an ideal LLC phase progression as a function of water content in the system. The gray shaded areas are the hydrophobic regions formed by the organic tails of the amphiphiles. The white open regions are the water domains.

FIG. 5. XRD spectra and PLM images of (a) a free-standing film of monomer 1 (y=6, x=10) with the Q_{I} phase containing 20 wt % of water, polymerized at 65° C., and (b) a free-standing film of monomer 1 with a L phase structure containing 10 wt % water, polymerized at 75° C.

FIG. 6. Mid-IR spectra of a supported Q_{I}-phase membrane of monomer 1 (y=6, x=10) showing almost complete disappearance of the 1004 cm⁻¹ C—H wagging band from the diene terminal —CH═CH₂ units: (a) before photopolymerization, and (b) after photopolymerization.

FIG. 7. Mid-IR spectra of (a) a supported Q_{I} membrane of monomer 1 (y=6, x=10) on hydrophilic Solupor® E075-9H01A support; and (b) a supported isotropic membrane of monomer 1 on hydrophobic Solupor® 14P01E support. (The ˜1700 cm⁻¹ absorbance band in IR spectrum of the supported Q_{I} membrane is attributed to the blank hydrophilic Solupor® E075-9H01A support.)

FIG. 8. Near-IR spectra of a glass-sandwiched and sealed Q_{I}-phase sample of monomer 1 (y=6, x=10) containing 80.0/19.4/0.6 (w/w/w) monomer 1/H₂O/2-hydroxy-2-methylpropiophenone before, during, and after photo-cross-linking at 65° C. The intensity of the water band at ca. 5130 cm⁻¹ remains almost constant, indicating that very little water loss occurs during photopolymerization at elevated temperatures under these conditions.

FIG. 9. Comparison of rejection properties of Q_{I}, AG, and NF-270 membranes (dead-end filtration; 400 psi; 2000 ppm aq. feed solutions, Q_{I}-phase of monomer 1 with y=6, x=10).

FIG. 10. Digital photo of the custom-made, stainless steel, 25-mm I.D., stirred dead-end filtration cell used in the high-pressure water NF and desalination studies.

FIG. 11. Powder XRD profile of a supported Q_{I} membrane of monomer 1 (y=6, x=10) after aqueous filtration at 400 psi for 144 h.

FIG. 12. Water flux of the supported Q_{I} membranes of monomer 1 (y=6, x=10) as a function of different applied pressures. Each point on the plot is the average value of at least 3 independent runs, and the error bars are the standard deviations for those runs.

FIG. 13. Calculated and experimentally measured % rejections for the neutral probe molecules of different sizes. The solid curve represents the calculated % rejections of the neutral organic solutes for a membrane with a uniform pore size (i.e., diameter) (a) of 0.75 nm using the Ferry equation (eqn 1). The data points (diamonds) represent the experimental % rejection data for the supported Q_{I} membranes. (ΔP: 400 psi, concentration of feed solutions: 2000 ppm).

FIG. 14. Model for applying the Ferry equation for rejection performance of membranes with uniform circular pores to a Q_{I}-phase system with a uniform water layer manifold to determine layer gap spacing.

FIG. 15. Comparison of thickness-normalized solution permeabilities of the Q_{I}-phase membrane of monomer 1 (y=6, x=10), AG membrane, and NF-270 membrane based on measured fluxes, applied pressure (400 psi), and active layer thickness. The active layer thickness of the Q_{I} membrane was measured to be 40 μm using a handheld micrometer. The thickness of the active layers of AG and NF-270 were both assumed to be 0.1 μm, which is a practical upper limit. The feed solutions were all 2000 ppm in solute concentration, and pre-filtered through 0.45-μm syringe filters prior to NF testing. The values shown are the average values of at least 3 independent sample runs with standard deviation error bars. (Left to right: Bicontinuous cubic, AG, NF-270).

FIG. 16. Representative solution flux data for supported Q_{I}-phase LLC membranes made from monomer 1(y=6, x=10). The concentration of all the feed solutions is 2000 ppm, and the applied pressure is 400 psi. The values shown are the average values of at least 3 independent sample runs with standard deviation error bars.

FIG. 17 shows an XRD plot of intensity vs. 2theta for a film of monomer 4, indicating the peaks at 1/sqrt(18) and 1/sqrt(22) characteristic of a Q-type phase. The fact that 50 wt % water is needed to form this Q phase is indicative of a high water content, normal (i.e. Type I) LLC phase.

FIG. 18 shows an XRD plot of intensity vs. 2theta for a film of monomer 4, indicating the peaks at 1/sqrt(8) and 1/sqrt(9). characteristic of a Q-type phase. The fact that 50 wt % water is needed to form this Q phase is indicative of a high water content, normal (i.e. Type I) LLC phase.

### DETAILED DESCRIPTION OF THE INVENTION

In an embodiment, the invention provides a composite nanofiltration membrane comprising: a porous support; and a porous crosslinked LLC polymer composition embedded within and/or on top of the support, the LLC polymer composition comprising a pore structure of interconnected pores. As used herein, a “membrane” is a barrier separating two fluids that allows transport between the fluids. A “fluid” may be a liquid or a gas. A “composite” membrane comprises a porous LLC polymer composition combined with a porous support; the LLC polymer composition may itself form a membrane.

As used herein, “nanoporous” signifies a pore size between about 0.5 and about 6 nm in diameter and a “nanofiltration membrane” has an effective pore size between about 0.5 and about 6 nm. “Ultraporous” signifies a pore size between about 2.5 and about 120 nm and an “ultrafiltration membrane” has an effective pore size between about 2.5 and about 120 nm. “Microporous” signifies a pore size between about 45 nm and about 2500 nm and a “microfiltration membrane” has an effective pore size between about 45 nm and about 2500 nm. The effective pore size of a membrane is the pore size of the part of the membrane which performs most of the separation function. In an embodiment of the composite nanofiltration membranes of the invention, the LLC polymer portion of the composite is nanoporous while the porous support has a larger average pore size. In an embodiment, the LLC polymer composition has an effective pore size between about 0.5 and 5.0 nm. In other embodiments the effective pore size greater than or equal to 0.5 to less than 2 nm, from 0.5 to 1 nm, or less than 1 nm.

As used herein, a “LLC polymer composition” comprises polymerized lyotropic liquid crystal (LLC) monomers in an ordered assembly. As used herein, “LLC monomers” are polymerizable amphiphilic molecules that spontaneously self-assemble into fluid, yet highly ordered matrices with regular geometries of nanometer scale dimension when combined with water or another suitable polar organic solvent. LLC mesogens are amphiphilic molecules containing one or more hydrophobic organic tails and a hydrophilic headgroup. As used herein, a “polymerizable LLC monomer” comprises a polymerizable group which allows covalent bonding of the monomer to another molecule such as another monomer, polymer or cross-linking agent. Suitable polymerizable groups include acrylate, methacrylate, diene, vinyl, (halovinyl), styrenes, vinylether, hydroxy groups, epoxy or other oxiranes (halooxirane), dienoyls, diacetylenes, styrenes, terminal olefins, isocyanides, acrylamides, and cinamoyl groups. In an embodiment, the polymerizable group is an acrylate, methacrylate or diene group. The LLC polymer composition may also comprise an initiator and/or a cross-linking agent.

LLC monomers useful for the present invention are those that form a bicontinuous cubic LC phase in the presence of water or other polar solvents. The bicontinuous cubic LC phase contains ordered nanopores of water or another polar organic solvent. LLC monomers useful for the present invention can be polymerized into a cross-linked network with substantial retention of the original LC phase microstructure. The LLC phase structure may be a polydomain structure, and therefore may display short-range rather than long-range order. As used herein, “nanometer scale dimension” refers to pore dimensions between about 0.5 and about 5 nm. LLC monomers useful for the present invention can form solvent nanopores having a diameter between about 0.5 and about 5 nm. As used herein, a “monodisperse” pore size has a variation in pore size from one pore to another of less than ca. 15% (specifically an ideally narrow Poisson distribution). For pores manifold systems formed by some LLC phases (e.g. bicontinuous cubic phases), the pore size of a given pore will vary along the pore channel. For pores whose dimensions vary along the pore channel, a comparison of pore sizes is made at equivalent positions along the channel. In an embodiment, the pore size is monodisperse when measured in this way. In an embodiment, the pore size may be measured by its minimum dimension.

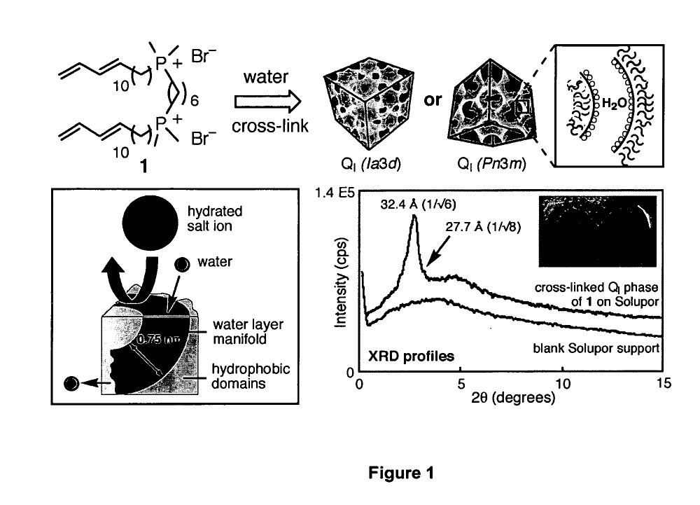

Polymerizable LLCs (i.e., cross-linkable surfactants) have been designed that spontaneously form type I bicontinuous cubic phases in the presence of a small amount of water or other polar solvent. A number of bicontinuous cubic (Q) phases have been identified; these phases are termed bicontinuous because they have two or more unconnected but interpenetrating hydrophobic and/or aqueous networks with overall cubic symmetry. Depending on where they appear on the phase diagram relative to the central lamellar (Lα) phase, these Q phases can be classified as Type I (oil-in-water or normal) or Type II (water-in-oil or inverted). FIG. 1 illustrates two Q_{I} phases (Ia3d and Pn3m) in which the interpenetrating organic networks (darker gray) are separated from one another by a continuous water layer surface (lighter gray to white) with overall cubic symmetry. In an embodiment, the polymerizable LLCs used in the practice of the invention form a Q_{I} phase in the presence of water or a polar solvent. For Q_{I} phases, the size of the gap between the organic portions of the structure determines the effective pore size of the structure for size exclusion of solutes. In an embodiment, the effective pore size of the structure may be determined by the size of the solute which can be excluded from the pore manifold. One method for calculating the effective pore size is explained in Example 2.

In an embodiment, the pore structure after polymerization is substantially determined or controlled by the Q phase which is formed by the monomers. In this case the pore structure may be said to be based on the bicontinuous cubic LLC structure. The pore structure after polymerization need not be identical to that of the bicontinuous cubic LLC phase. In some LLC phases, contraction of the structure is observed on heavy cross-linking of the polymer into a network. Expansion of Q_{I} unit cells has been observed for some LLC monomers (Pindzola et al., 2003, J. Am. Chem. Soc. 125(10), 2940-2949). Some disordering of the phases may also be observed upon cross-linking, as evidenced by a loss in X-ray diffraction (XRD) peak intensity (Pindzola, 2003). In an embodiment, the pore structure of the polymerized network retains at least part of the bicontinuous cubic phase structure and comprises interconnected, ordered 3-D nanopores. Retention of the bicontinuous cubic phase structure can be confirmed through observation of XRD peaks characteristic of the structure.

Several polymerizable LLCs are known to spontaneously form type I bicontinuous cubic (Q_{I}) LC phases. These mesogens include gemini surfactant monomers. Monomer 1 forms a bicontinuous cubic phase (Pindzola, B. A., Ph.D. Thesis (2001), University of California, Berkeley; Pindzola, 2003). In an embodiment, the spacer and tail length of the Gemini surfactant are “matched”, with larger spacer lengths corresponding to longer tail lengths. In different embodiments, x is 8, 10 or 14 and y is 2, 4, or 6; y=2 and x=10; y=6 and x=10, y=8 and x=10, y=8 and x=14.

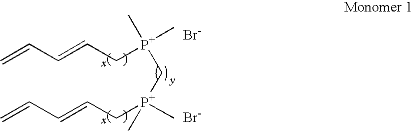

Polymerizable gemini cationic imidazolium surfactants based on room temperature ionic liquids have also been developed and are described in United States Published Patent Application US-2008-0029735-A1, which is hereby incorporated by reference. These surfactants can form bicontinuous cubic (Q) phases when mixed with water or room temperature ionic liquids. In an embodiment, the surfactant composition has the general formula:

HₙXₙL₍ₙ₋₁₎Yₙ Formula 1

where n is greater than or equal to 2; H is a hydrophilic head group comprising a five membered aromatic ring containing two nitrogens (e.g. an imidazolium ring); X is an anion, L is a spacer or linking group which connects two rings, and Y is a hydrophobic tail group attached to each ring and having at least 10 carbon atoms which optionally comprise a polymerizable group P. Each spacer L is attached to a first nitrogen atom in each of the two linked rings. The attachment may be through a covalent or a noncovalent bond such as an ionic linkage. Each hydrophobic tail group Y is attached to the second (other) nitrogen atom in each ring. The combination of the hydrophilic head group H, the linker L, and the hydrophobic tail Y form an imidazolium cation. Hydrophobic tails may also be attached to one or more carbon atoms of the ring.

In an embodiment, the anion, X, is a standard anion that is chemically inert and very hydrophilic for good interaction/compatibility with water for LLC phase formation. These anions include, but are not limited to, Br⁻, BF₄⁻, Cl⁻, I⁻, CF₃SO₃⁻, Tf₂N⁻, PF₆⁻, DCA⁻, MeSO₃⁻, and TsO⁻. In an embodiment, the anion X is selected from the group consisting of Br and BF₄—.

In another embodiment, the anion X is selected from the group consisting of a halide anion, a triflate anion, an alkyl sulfonate anion (RSO₃⁻), a dicyanamide anion, a methyl sulfonate anion (MeSO₄), or BF₄⁻ This set of anions may be used when the imidazolium surfactant is mixed with water.

The spacer L can be an alkyl group, an ether group, an amide, an ester, an anhydride, a phenyl group, a perfluoroalkyl, a perfluoroether, or a siloxane. In an embodiment, L is an alkyl group having from 1 to about 12 carbons, or an ether group having from 1 to about 6 ethers. In an embodiment, L is an ether group having from 1 to 3 ethers. In addition, the spacer L can include a pendant functional group such as a catalytic group or a molecule receptor.

Y is a hydrophobic tail group having at least 10 carbon atoms. The tail group may be linear or branched. A linking group may be placed between the tail and the ring. In an embodiment, Y is a linear alkyl chain. In another embodiment, Y comprises a polymerizable group P. Suitable polymerizable groups include acrylate, methacrylate, diene, vinyl, (halovinyl), styrenes, vinylether, hydroxy groups, epoxy or other oxiranes (halooxirane), dienoyls, diacetylenes, styrenes, terminal olefins, isocyanides, acrylamides, and cinamoyl groups. In an embodiment, the polymerizable group is an acrylate, methacrylate or diene group.

In an embodiment, n=2 and the surfactant composition have the general formula:

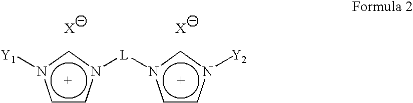

In another embodiment, n=2 and the surfactant composition have the general formula:

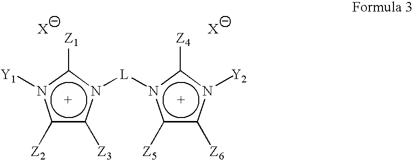

In Formula 3, Z₁ through Z₆ are individually selected from the group consisting of hydrogen and hydrophobic tail groups having at least 10 carbon atoms which optionally comprise a polymerizable group P. Attachment of a hydrophobic tail to one or more carbon atoms in the ring in addition to the hydrophobic tail attached to the nitrogen can be used to tune LLC phase structure and curvature.

Monomer 2 and monomer 3 are imidazolium-based gemini surfactants and polymerizable surfactants (respectively) that form Q LLC phases with RTILs and water as the polar solvent. In an embodiment, m is from 0 to 10 and R═(CH₂)ₓ with x is from 1 to 12 or , R═((CH₂)₂O)_{y}(CH₂)₂, and y is from 1 to 6. In other embodiments, m is 0 to 6 or 3-7. In another embodiment, surfactants which form the bicontinuous cubic phase have R═(CH₂)ₓ, x=6, and X⁻=BF₄⁻. Surfactants which form the bicontinuous cubic phase also can have R═((CH₂)₂O)_{y}(CH₂)₂ and y=1 or 2, X⁻=halide ion (e.g., Br—⁻), and m=3-7. In an embodiment, R═((CH₂)₂O)_{y}(CH₂)₂ with y=1, X⁻=Br⁻, m=5, and PG=diene, illustrated as monomer 4.

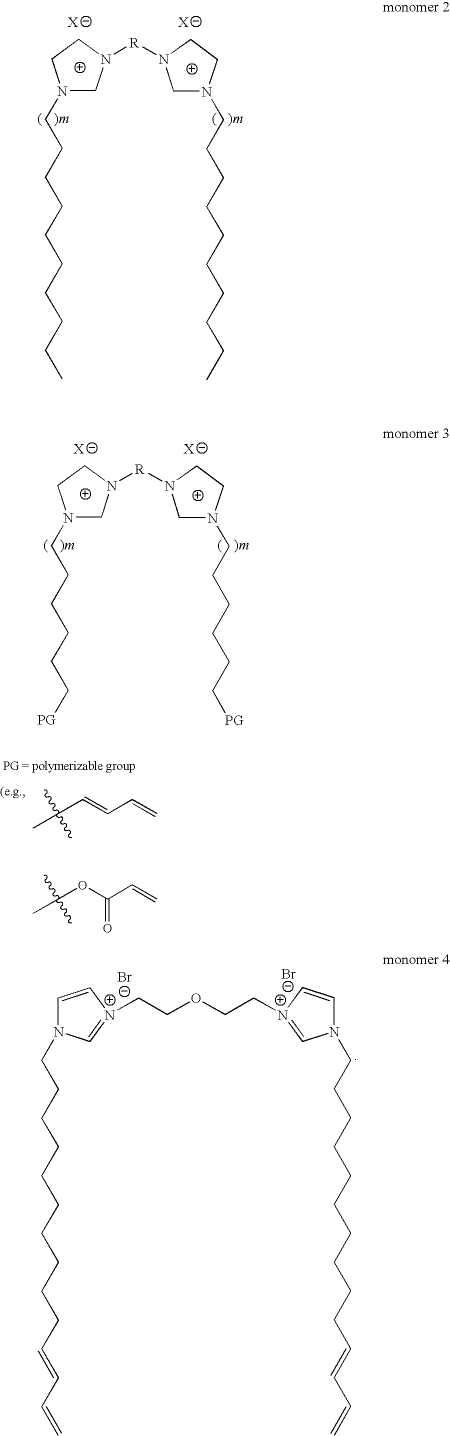

Single tail monomers with a relatively large hydrophilic headgroup and a single tail with a polymerizable group can also have the “truncated cone” shape typically required to pack in the presence of water to form type I Q phases. These simpler, non-cross-linkable LLC monomers are expected to form similar Q_{I} phases, but will typically employ added cross-linker to make a robust network. A single tailed monomer with similarities to monomer 1 (tetradeca-11,13-dienyl-trimethylphosphonium bromide) can be used with added cross-linker to form a cubic network upon photopolymerization (Pindzola, B. A.; Hoag, B. P.; Gin, D. L. J. Am. Chem. Soc. 2001, 123 (19), 4617-4618). This monomer is a polymerizable phosphonium analog of alkyltrimethylphosphonium bromide surfactants which have a truncated cone shape and are known to form a Q_{I} phase with Ia3d symmetry (Pindzola, B. A.; Gin, D. L. “Lyotropic Liquid-Crystalline Phase Behavior of Some Alkyltrimethylphosphonium Bromides,” Langmuir 2000, 16 (16), 6750-6753; McGrath, K. M. “Langmuir 1995, 11, 1835; Auvray et al., J. Phys. Chem. 1989; 93, 7458)

In an embodiment, the hydrophilic headgroup in all of these Q_{I} phase-forming LLC monomers can be any organic or inorganic hydrophilic ionic or neutral group. They do not have to be phosphonium or imidazolium-based, but may be phosphonium-based or imidazolium-based. Also, these Q_{I} phase-forming LLC monomers can have one or more polymerizable tails with different types of polymerizable groups such as dienes, acrylates, etc. It is believed that an extremely important factor in making LLC monomers that will produce the desired Q_{I} phases is getting the aspect ratio or molecular shape right (truncated cone shape with the hydrophilic end the larger end) so that packing will prefer the Q_{I} phases.

The pore size of the nanoporous LLC assemblies can be tuned via modification of the parent LC monomer. (Resel, R.; Leising, G.; Markart, P.; Kreichbaum, M.; Smith, R.; Gin, D. “Structural Properties of Polymerised Lyotropic Liquid Crystal Phases of 3,4,5-Tris(ω-acryloxyalkoxy)benzoate Salts,” Macromol. Chem. Phys. 2000, 201 (11), 1128). It is believed that the pore size for bicontinuous cubic phases can extend up to 5 nm. Pore size and pore architecture may also be tuned by changing temperature, pressure, and mixture composition, since LLC phase behavior is known to depend on all three parameters. It is believed that the sub-one nanometer uniform water layer manifold gap size can be systematically tuned by (a) changing the nature and size of the counterion on the LLC monomer; (b) changing the spacer length between the hydrophilic headgroups and the length of the polymerizable tails on the gemini LLC to as to modulate the “truncated cone shape” of the molecule.

In an embodiment, the pores of the LLC polymer composition are hydrophilic. These pores may be filled with water or an aqueous solution. In an embodiment, the pores of the LLC polymer composition may be filled with water or an aqueous solution by using these liquids as the solvent in the LLC mixture. In another embodiment, the solvents used in the LLC mixture may be replaced with water or the aqueous solution of interest after polymerization of the LLC mixture.

In an embodiment, the LLC polymer composition is embedded or located within the pores of the support. In the portions of the support containing the LLC polymer composition, the LLC polymer composition fills enough of the pore space of the support so that separation process is controlled by the pores of the LLC polymer composition. In an embodiment, there are no “non-LLC” pores with a pore size greater than that of the LLC polymer composition which traverse the composite membrane. In an embodiment, the LLC polymer composition is present throughout the thickness of the support, so that the thickness of the composite membrane may be taken as the thickness of the support. During fabrication of the composite membrane, the LLC mixture may be applied to only a portion of the surface of the support. The LLC polymer composition may be retained within the support by mechanical interlocking of the LLC polymer composition with the support.

In another embodiment, the LLC polymer composition forms a layer on the surface of the support; this layer acts as a membrane. In different embodiments, the thickness of this layer is less than 10 microns, less than 5 microns, less than 2 microns, less than 1 micron, or less than 0.5 micron.

In an embodiment, the porous support is hydrophilic. As used herein, a hydrophilic support is wettable by water and capable of spontaneously absorbing water. The hydrophilic nature of the support can be measured by various methods known to those skilled in the art, including measurement of the contact angle of a drop of water placed on the membrane surface, the water absorbency (weight of water absorbed relative to the total weight, U.S. Pat. No. 4,720,343) and the wicking speed (U.S. Pat. No. 7,125,493). The observed macroscopic contact angle of a drop of water placed on the membrane surface may change with time. In different embodiments, the contact angle of a 2 μL drop of water placed on the support surface (measured within 30 seconds) is less than 90 degrees, from 5 degrees to 85 degrees, zero degrees to thirty degrees or is about 70 degrees. In another embodiment, the membrane is fully wetted by water and soaks all the way through the membrane after about one minute. Hydrophilic polymeric supports include supports formed of hydrophilic polymers and supports which have been modified to make them hydrophilic. In another embodiment, the support is hydrophobic.

Typically, the porous support membrane has a smaller flow resistance than the LLC membrane. In an embodiment, the porous support in this system is selected so that the diameter of the pores is less than about 10 microns and greater than the effective pore size of the LLC polymer composition. In different embodiments, the support is microporous or ultraporous. In different embodiments, the support has a pore size less than about 0.1 micron or from 0.1 micron to 10 microns. The preferred pore size of the support may depend on the composition of the LLC mixture. The characteristic pore size of the membrane may depend on the method used to measure the pore size. Methods used in the art to determine the pore size of membranes include Scanning Electron Microscopy analysis, capillary flow porometry analysis (which gives a mean flow pore size), measurement of the bubble pressure (which gives the largest flow pore size), and porosimetry.

The porous support membrane gives physical strength to the composite structure. When the LLC polymer composition is somewhat brittle, the support membrane can also add flexibility to the composite membrane. The support should also be thermally stable over approximately the same temperature range as the LLC membranes to be used.

The support is selected to be compatible with the solution used for LC membrane formation, as well as to be compatible with the liquid or gas to be filtered. When the solution used for LC membrane fabrication and the support are compatible, the support is resistant to swelling and degradation by the solution used to cast the LC polymer porous membrane. In an embodiment, the organic solvent used in the solution and the support are selected to be compatible so that the support is substantially resistant to swelling and degradation by the organic solvent. Swelling and/or degradation of the support by the solvent can lead to changes in the pore structure of the support. In an embodiment, if the membrane is to be used for water based separations, the porous support is sufficiently hydrophilic for water permeation.

The porous support may be made of any suitable material known to those skilled in the art including polymers, metals, and ceramics. In various embodiments, the porous polymer support comprises polyethylene (including high molecular weight and ultra high molecular weight polyethylene), polyacrylonitrile (PAN), polyacrylonitrile-co-polyacrylate, polyacrylonitrile-co-methylacrylate, polysulfone (PSf), Nylon 6, 6, poly(vinylidene difluoride), or polycarbonate. In an embodiment, the support may be a polyethylene support or a support of another polymer mentioned above (which may include surface treatments to affect the wettability of the support). The support may also be an inorganic support such as a nanoporous alumina disc (Anopore J Whatman, Ann Arbor, Mich.). The porous support may also be a composite membrane.

The flux rate through the composite membrane as a whole depends upon the pressure differential applied across the membrane as well as on the permeability of the LLC polymer membrane. The composite membranes of the invention are capable of sustaining pressure differences of greater than 100 psi or greater than 400 psi and obtaining aqueous solution flux rates greater than about 0.005 or 0.01 L m⁻² h for a pressure differential of 60 psi and 0.005 or 0.060 L m⁻² h for a pressure differential of 400 psi. In different embodiments, the composite membrane has a thickness-normalized water permeability of greater than 0.04, 0.06, or 0.08 L m⁻² h⁻¹ bar⁻¹ μm.

Furthermore, the LLC polymer membrane can be fabricated with chemical complexing agents in the nanopores. These chemical complexing agents may be inorganic or organic entities that have the ability to interact reversibly or irreversibly with various solutes that enter the membrane. These chemical complexing agents may include, but are not limited to, metal ions such as Cu⁺, Cu²⁺, Ag⁺, Co²⁺, Sc³⁺, and amine functionalities. However, incorporation of these agents may change the effective pore size of the membrane.

In an embodiment, the solution used for applying the LLC monomer, also known as the “LLC mixture”, comprises a plurality of polymerizable LLC monomers, an aqueous or polar organic solvent, and a polymerization initiator. A single species of polymerizable LLC monomer may be used, but a plurality of monomers is required for phase formation. The aqueous or polar solvent is selected so that the LLC monomer forms the desired Q_{I} phase. Because of the LLC phase formation, the solution formed may not be uniform. The mixture components do not include the porous support. In an embodiment, suitable polar liquid solvents include, but are not limited to water, dimethylformamide, and THF and room temperature ionic liquids. In another embodiment, suitable polar organic solvents suitable as water substitutes for LLC assembly include ethylene glycol, glycerol, formamide, N-methylformamide, dimethylformamide, and N-methylsydnone, most of which are fairly water-miscible, protic organic solvents with the exception of N-methylsydnone. RTILs are polar, molten organic salts under ambient conditions that are typically based on substituted imidazolium, phosphonium, ammonium, and related organic cations complemented by a relatively non-basic and non-nucleophilic large anion. In an embodiment, the solvent is aqueous. The polymerization initiator can be photolytically or thermally activated. The mixture is thoroughly combined. In an embodiment, mixing may be performed through a combination of hand mixing and centrifuging.

In an embodiment, the LLC mixture does not further comprise a hydrophobic polymer as described by Lu et al. (Lu, 2006) and U.S. Pat. No. 7,090,788. As used herein, a polymer is a substance composed of macromolecules, the structure of which essentially comprises the multiple repetition of units derived from molecules of low relative molecular mass.

The LLC mixture may further comprise an optional cross-linking agent molecule to help promote intermolecular bonding between polymer chains. The cross-linking agent is not required if the monomer can cross-link without a cross-linking agent. In an embodiment, the cross-linking agent is not a polymer. In an embodiment, the cross-linking agent has less than 10 monomeric repeat units and/or has a weight less than 500 Daltons. Typically, the cross-linking agent or curing agent is a small molecule or monomeric cross linker such as divinyl benzene (DVB). Cross-linking agents are known to those skilled in the art. The amount of cross-linking agent is small enough to allow formation of the desired Q_{I} LLC phase. The cross-linker will typically be hydrophobic, in order to dissolve in and help to cross-link the hydrophobic tail regions of the Q_{I} LLC phase. For water filtration applications, it is believed that the incorporation of additional hydrophobic components into the LLC mixture should be limited to prevent the overall polymeric composition from being too hydrophobic for good water filtration. In an embodiment, the maximum amount of cross-linking agent is 10 wt % to 15 wt %. In an embodiment, when the cross-linking agent is hydrophobic its size is kept small enough so that reduction of the overall density or surface coverage of the polar solvent (e.g. water) nanopores is limited.

The mixture may further comprise an organic solvent for formulation or delivery of the LLC monomer (e.g. for solvent casting). The solvent may be any low boiling point organic solvent that dissolves the monomer. A mixture of one or more solvents may also be used. Useful solvents include, but are not limited to, methanol and diethyl ether. In one embodiment, the monomer is dissolved in the organic solvent, and then the water and the optional cross-linking agent are added. In an embodiment, the organic solvent used in the solution and the support are selected to be compatible so that the support is substantially resistant to swelling and degradation by the organic solvent. Swelling and/or degradation of the support by the solvent can lead to changes in the pore structure of the support.

The composition of the LLC mixture may be selected to obtain the desired bicontinuous phase based on the phase diagram for the LLC monomer. For example, at atmospheric pressure the LLC phases present in the system may be determined as a function of temperature and percentage of amphiphile (LLC monomer) in the system (e.g., Pindzola, 2003). The percentage of LLC monomer in the mixture and the temperature can then be selected together to obtain the desired bicontinuous cubic phase. When the phase of LLC mixture is sensitive to the water or other solvent content, steps can be taken to minimize evaporative water or solvent loss during the membrane fabrication process.

In an embodiment, when the LLC monomer is monomer 1, the weight percent of water in the LLC mixture is from 5% to 15 wt %. Temperature control may be needed to maintain the phase during the photo-cross-linking after infiltration into the support membrane (i.e., ca. 70° C.).

In an embodiment, when the LLC monomer is monomer 3, the weight percent of water in the LLC mixture is from 33% to 65 wt %. Monomer 4 may be processed at room temperature.

In an embodiment, the LLC mixture is assembled into the desired bicontinuous cubic phase before the mixture is contacted with the porous support. The mixture may be allowed to rest at room temperature or at any suitable temperature dictated by the phase diagram. Analysis of the LLC phases can be performed by several methods known to those skilled in the art including polarized light microscopy (PLM) and x-ray diffraction (XRD). Q phases are optically isotropic (have a black optical texture) when viewed with the PLM. XRD of Q phases exhibit symmetry-allowed d spacings that ideally proceed in the ratio 1:1/sqrt(2): 1/sqrt(3): 1/sqrt(4): 1/sqrt(5): 1/sqrt(6): 1/sqrt(8): 1/sqrt(9): 1/sqrt(10): . . . corresponding to the d₁₀₀, d₁₁₀, d₁₁₁, d₂₀₀, d₂₁₀, d₂₁₁, d₂₂₀, d₂₂₁ (or d₃₀₀), d₃₁₀, . . . diffraction planes. The presence of Q phases with P or I symmetry in polydomain small molecule amphiphile and phase separated block copolymer systems has generally been identified on the basis of a black optical texture and a powder XRD profile in which the 1/sqrt(6): and 1/sqrt(8): d spacings (i.e. the d₂₁₁ and d₂₂₀ reflections) are at least present (Pindzola, 2003). The higher order XRD reflections can be used to distinguish between the different 3-D cubic phase architectures, since systematic XRD absences in the XRD peaks result as the cubic cells becomes more complex. However, the higher order reflections may not be observed when the phases do not possess a great deal of long range order. In an embodiment, the LLC mixture has a fluid gel-like consistency before cross-linking or polymerization.

In an embodiment where the LLC polymeric composition is embedded into the support, a quantity of the LLC mixture is placed on a surface of the porous support membrane and then infused into the porous support. In one aspect of the invention, the support is impregnated with the LLC mixture using a combination of heat and pressure to drive the LLC mixture into the pores of the support. The temperature and pressure are selected so that Q_{I} phase is still retained. The LLC mixture and support may be heated to decrease the viscosity of the LLC mixture before pressure is applied. In an embodiment, a heated press may be used to impregnate the support with the LLC mixture. When a press is used, the LLC mixture and support membrane may be sandwiched between a pair of load transfer plates. Additionally, a pair of polymeric sheets may be used to facilitate release of the support mixture and membrane from the load transfer plates and limit evaporation of water from the mixture. Suitable dense polymeric sheets that are transparent to UV or visible light include, but are not limited to, Mylar® (a biaxially-oriented polyester film made from ethylene glycol and dimethyl teraphthalate). The LLC mixture need not completely fill the pore space of the support, but fills enough of the pore space of the support so that separation process is controlled by the pores of the LLC polymer composition. In an embodiment, the gel is pushed uniformly through the entire support membrane thickness.

After impregnation of the support with the LLC mixture, the LLC monomers are then cross-linked to form the LLC polymer composition. In an embodiment, the LLC monomers are polymerized by cross-linking of the hydrophobic tails. In an embodiment, the LLC phase can be photo-cross-linked by putting it under UV light in air or nitrogen at ambient temperature (or at the required temperature to maintain the desired LLC phase). Other temperatures as known by those skilled in the art may be used during the cross-linking process. Other methods of cross-linking as known to those skilled in the art may also be used. For example, thermal cross-linking may be performed using a cationic initiator as a cross-linking agent. The degree of cross-linking can be assessed with infrared (IR) spectroscopy. In different embodiment, the degree of polymerization is greater than 90% or greater than 95%.

In other embodiments, the LLC polymer composition is formed as a thin, supported top-film on top of the support. In different embodiments, the coating of the LLC monomer mixture can be formed by solution-casting the LLC monomer mixture to make thin films on membrane supports after evaporation of the delivery solvent; doctor-blade draw-casting of the initial viscous Q_{I}-phase LLC monomer gel; or roll-casting of the LLC mixture at elevated temperature. It is preferred that that coating be free of surface defects such as pinholes and scratches. In one embodiment, a commercial foam painting sponge or other such applicator can be used to apply the solution to the support. In another embodiment, the solution can be applied by roller casting. The amount of material on the support can be controlled by the number of applications and the concentration of the casting solution. If desired, more than one layer of solution may be applied to the support to form multiple layers of porous LC polymer and thereby control the film thickness.

It is believed that some of the solution penetrates into the support, with the extent of penetration depending on the nature of the solution, the support, and the application process. The penetration of the solution into the support is believed to help attach the cross-linked LLC polymer film to the support. When the Q_{I} phase is sensitive to the solvent content of the LLC mixture, the solvent content (e.g. water content) is controlled during processing to maintain the desired Q_{I} phase. In an embodiment, the solvent content can be controlled by limiting evaporation of solvent from the film. Evaporation of the solvent can be controlled by sandwiching the LLC film and support between polymer sheets, processing the LLC film and support in an enclosure in which the atmosphere is controlled (e.g. the humidity level is controlled), and by other methods known to those skilled in the art. Enclosing the LLC film can also prevent other components from entering into LLC monomer film.

In an embodiment, the invention provides a process for separating a component of a first fluid mixture, the process comprising the steps of:

bringing said first fluid mixture into contact with the inlet side of a separation membrane of the present invention comprising a porous LLC polymer composition attached to a support membrane, the LLC polymer composition comprising a pore structure of ordered, interconnected, three-dimensional pores;

applying a pressure difference across said separation membrane; and

withdrawing from the outlet side of said separation membrane a second fluid mixture wherein the proportion of said component is depleted, compared with said first fluid mixture.

Components which can be separated from a fluid mixture using the membranes of the invention include organic molecules, ions, gases, impurities and other contaminants.

The invention provides methods of size-selective filtration of solutions using the composite membrane of the invention. One or more components such as nanometer-size impurities, organic molecules, certain ions, and other contaminants can be removed from solution by selecting the pore diameter of the LLC membrane to be smaller than the molecular size of the component(s) of interest.

Furthermore, the invention provides methods for other forms of separation processes. If a chemical complexing agent is incorporated into the nanopores of the composite membrane of the invention, the chemical complexing agent can interact reversibly or irreversibly with various solutes that enter the membrane. For example, if metal ions such as Cu⁺, Cu²⁺, and Ag⁺ are incorporated into the nanopores, enhanced oxygen separation or separation of olefins from paraffins can be enabled. Amine functionalities would enable enhanced CO₂ separation from other gases. Similarly, the incorporation of water-stable catalytic entities in the nanopores of these materials may also offer the option of catalytically degrading organic waterborne contaminants into more biodegradable forms during the nanofiltration process. The incorporation of chemical complexing or reactive agents into LLCs is known to the art (Gu, W.; Zhou, W.-J.; Gin, D. L. “A Nanostructured, Scandium-Containing Polymer for Heterogeneous Lewis Acid Catalysis in Water,” Chem. Mater. 2001, 13 (6), 1949-1951.; Gray, D. H.; Gin, D. L. “Polymerizable Lyotropic Liquid Crystals Containing Transition-Metal Ions as Building Blocks for Nanostructured Polymers and Composites,” Chem. Mater. 1998, 10 (7), 1827-1832.; Deng, H.; Gin, D. L.; Smith, R. C. “Polymerizable Lyotropic Liquid Crystals Containing Transition-Metal and Lanthanide Ions: Architectural Control and Introduction of New Properties into Nanostructured Polymers,” J. Am. Chem. Soc. 1998, 120 (14), 3522-3523).

Those of ordinary skill in the art will appreciate that materials and methods other than those specifically described herein can be employed in the practice of this invention without departing from the scope of this invention.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general, the terms and phrases used herein have their art-recognized meaning, which can be found by reference to standard texts, journal references and contexts known to those skilled in the art. The following definitions are provided to clarify their specific use in the context of the invention.

One skilled in the art readily appreciates that the present invention is well adapted to carry out the objects and obtain the ends and advantages mentioned, as well as those inherent in the present invention. The methods, components, materials and dimensions described herein as currently representative of preferred embodiments are provided as examples and are not intended as limitations on the scope of the invention. Changes therein and other uses which are encompassed within the spirit of the invention will occur to those skilled in the art, are included within the scope of the claims.

Although the description herein contains certain specific information and examples, these should not be construed as limiting the scope of the invention, but as merely providing illustrations of some of the embodiments of the invention. Thus, additional embodiments are within the scope of the invention and within the following claims.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or enantiomer of the compound is not specified, for example, in a formula or in a chemical name, that description is intended to include each isomers and enantiomer of the compound described individual or in any combination. One of ordinary skill in the art will appreciate that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and sub-ranges, as well as all individual values included in the ranges given are intended to be included in the disclosure. When a Markush group or other grouping is used herein, all individual members of the group and all combinations and subcombinations possible of the group are intended to be individually included in the disclosure.

### Example 1

### Fabrication of a Composite Membrane Based on a Cross-Linked Bicontinuous Cubic Lyotropic Liquid Crystal Assembly

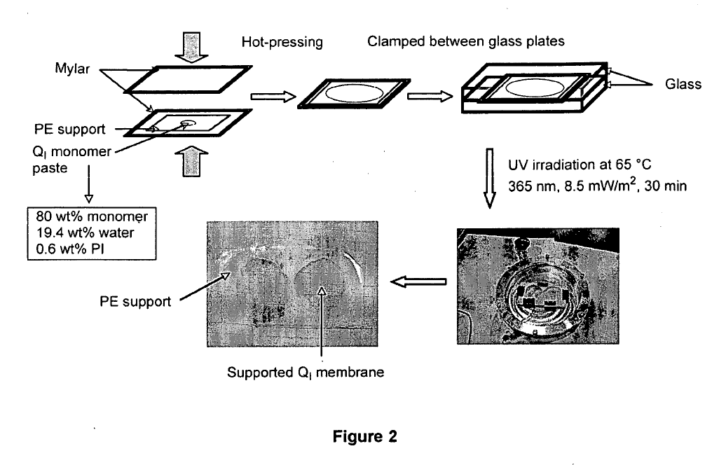

A hot-pressing method similar to that used to make supported Q_{I}-phase 1-BR composite films (Lu, X.; Nguyen, V.; Zhou, M.; Zeng, X.; Jin, J.; Elliott, B. J.; Gin, D. L. Adv. Mater. 2006, 18, 3294) was employed to make supported membranes for NF testing, since conventional solvent-casting was ineffective. This method involves heating (70° C.) and pressing (12 tons force) the initial Q_{I}-phase monomer mixture [80.0/19.4/0.6 (w/w/w) monomer1 (y=6, x=10)/H₂O/radical photo-initiator] into a 35-40 μm thick, commercial, microporous, hydrophilic, polyethylene fiber matte support (Solupor® E075-9H01A). In this process, the LLC monomer gel is completely infused through the support and then radically photo-cross-linked at 65° C. with 365 nm light to lock-in the Q_{I} phase (see below.). The presence of d-spacings with a ratio of 1/√6:1/√8 in the powder X-ray diffraction (XRD) profile (Pindzola, 2003; Lu, 2006) of the membranes (FIG. 2) confirms that the Q_{I} phase is retained after polymerization. The degree of diene polymerization was found to be >95% using mid-IR spectroscopy (see below.). The resulting 40-μm thick, optically transparent membranes (FIG. 2) are flexible, uniform, and structurally stable under various test conditions, including sustained exposure to 400 psi water pressure, or drying in vacuo (45 mtorr) for days (see below, Example 2.).

### Experimental Section:

Materials. LLC monomer 1 (y=6, x=10) was prepared according to literature procedures (Pindzola, 2003). Structural and chemical characterization data for the synthesized monomer were consistent with those reported in the literature (Pindzola, 2003). Samples of AG membrane (a commercial low-presssure RO membrane) were provided by GE-Osmonics, Inc, (Minnetonka, Minn.), and stored in air-tight zip-top bags away from light to minimizing aging and oxidation of the active RO top-layer. Samples of NF-270 membrane (a commercial nanoporous NF membrane) were provided by Dow FilmTec (Edina, Minn.). The NF-270 samples were also stored in air-tight zip-top bags away from light to minimizing aging and oxidation of the active top-layer. Solupor® brand polyethylene (PE) microporous support membranes (Solupor® E075-9H01A and Solupor® 14P01E) were provided by DSM Solutech (Geleen, The Netherlands). Mylar sheets were purchased from American Micro Industry, Inc. 2-Hydroxy-2-methylpropiophenone (a radical photo-initiator) was purchased from Sigma-Aldrich. The water used in LLC phase formulation and all water filtration experiments was de-ionized and had a resistivity of >18 MΩcm⁻¹. PEG-600 molecular weight standard (PDI=1.1) was purchased from Polysciences, Inc. Glycerol was purchased from Mallinckrodt. Glucose, sucrose, ethylene glycol, Ethidium Red, 10-methyl-9-phenylacridinium chloride, 5-methyl-phenanthridinium iodide, 1-methylquinolinium iodide, and 1,4-dimethylpyridine iodide were all purchased from Sigma-Aldrich. Sodium chloride, calcium chloride, and magnesium chloride were purchased from Fisher Scientific. All chemicals were used as received.

Instrumentation. The LLC mixtures were mixed using an IEC Centra-CL2 centrifuge. Hot-pressing for the preparation of supported LLC membranes was conducted using a Wabash Genesis heated platen hydraulic press. Powder X-ray-diffraction (XRD) profiles were obtained with an Inel CPS 120 diffraction system equipped with a programmable capillary oven, using monochromated Cu K_{α} radiation. All XRD spectra were calibrated against silver behenate as a diffraction standard (d₁₀₀=58 Å), so the accuracy is within 1 Å up to the value of the d-spacings. XRD measurements were all performed at ambient temperature (21±1° C.), unless otherwise noted. Polarized optical microscopy (POM) studies were performed using a Leica DMRXP polarizing light microscope equipped with an Optronics digital camera assembly. FT-IR studies were performed with a Nicolet MAGNA-IR 760 spectrometer. Photopolymerizations were conducted using a Spectroline XX-15A 365 nm UV lamp (8 mW cm⁻² at the sample surface). UV light fluxes at the sample surface were measured using a Spectroline DRC-100× digital radiometer equipped with a DIX-365 UV-A sensor. Photopolymerizations were conducted in a custom-made, temperature-controlled photopolymerization chamber with an aluminum base, a Pyrex® glass plate cover, and a thermocouple to monitor the temperature inside the chamber.

Fabrication of supported Type I bicontinuous cubic (Q_{I}) membranes of monomer 1 using a modified hot-pressing method. Conventional solvent-casting proved ineffective in forming supported membranes because the initial Q_{I}-phase of monomer 1 is sensitive to water content in the system, and there is some water loss during solvent evaporation in the typical solvent-casting process (in which the sample film is exposed to the external environment). Therefore, a hot-pressing method similar to that used to make supported films of the monomer 1-BR composite (Lu, 2006) was employed: First, a Q_{I}-phase monomer gel mixture containing 80.0/19.4/0.6 (w/w/w) monomer 1/H₂O/2-hydroxy-2-methylpropiophenone was prepared by alternately hand-mixing and centrifuging (3800 rpm, 15 min) three times (Pindzola, 2003; Lu, 2006). Then, this mixture was kept at ambient temperature for 24 h before being processed into a supported membrane. Formation of a Q_{I} phase in the resulting optically transparent, colorless thick gel mixture was confirmed by the presence of a black optical texture under the POM and XRD peaks with a d-spacing ratio of 1/√6:1/√8 (sometimes with an additional observed peak at 1/√20). This LLC monomer mixture was then applied onto membrane support film and photo-cross-linked with retention of the LLC structure. FIG. 2 shows preparation of supported, cross-linked Q_{I}-phase LLC membranes of monomer 1 on Solupor® E075-9H01A support via hot-pressing and free radical photopolymerization at elevated temperatures. (Each grid square in the photo is 0.25×0.25 inches in size.) In particular, small amount of the LLC monomer gel mixture was first placed on a piece of hydrophilic microporous polyethylene support membrane (Solupor® E075-9H01A). Then the gel mixture together with the microporous membrane support was sandwiched between Mylar sheets and placed between smooth AI plates. The entire assembly was then pressed using a Wabash Genesis heated platen hydraulic press that was pre-heated to 70° C., by applying a force of 12 tons to a ca. 80 cm² piece of Solupor® E075-9H01A (ca. 2400 psi) for 5 min to infuse the monomer mixture completely through the support film. The resulting infused film (still between Mylar sheets) was then placed in a specially designed photopolymerization chamber (with an aluminum base and a Pyrex® glass plate cover) pre-heated to 65° C. on a hot-plate. The assembly was maintained at this temperature for 15 min and then irradiated with a 365 nm UV light (ca. 8 mW cm⁻² at the sample surface) for 30 min to photo-cross-link the Q_{I}-phase microstructure. Optically transparent supported membranes with the Q_{I}-phase structure were obtained using this method. According to FT-IR analysis before and after photopolymerization, the degree of diene polymerization was found to >95% (see subsequent sections on degree of polymerization characterization).

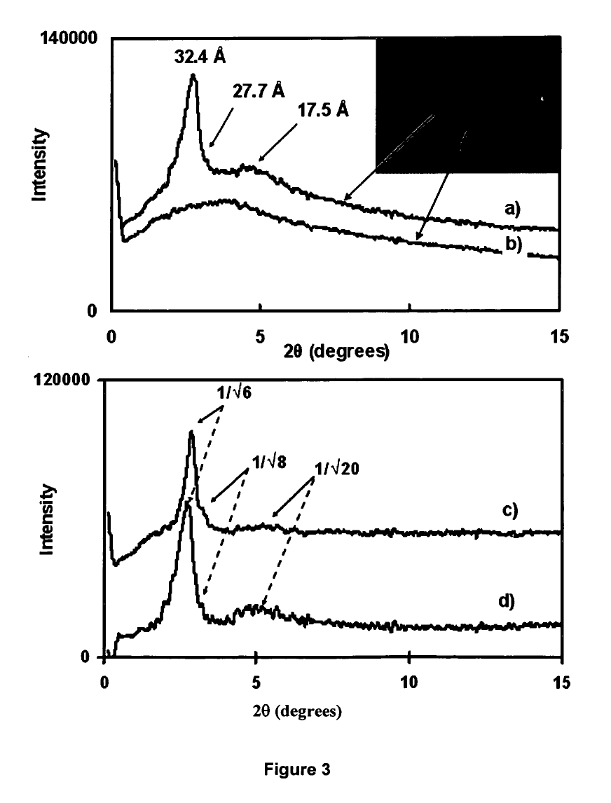

Powder XRD analysis of the supported, cross-linked LLC membranes shows diffraction peaks with a d-spacing ratio of 1/√6:1/√8, which is characteristic of a Q phase with either the Ia3d or Pn3m structure (Pindzola, 2003). The XRD spectrum of the Solupor®-supported Q_{I}-phase membrane of monomer 1 is virtually identical to that of a bulk Q_{I}-phase resin of monomer 1 (FIG. 3) FIG. 3 shows XRD profiles of (a) a photo-cross-linked supported Q_{I} membrane of monomer 1 on Solupor® E075-9H01A; (b) a piece of blank Solupor® E075-9H01A support; (c) a free-standing Q_{I}-phase film of monomer 1; and (d) the supported Q_{I} membrane after subtraction of the baseline XRD spectrum of the blank Solupor® E075-9H01A support film. A digital picture of the supported Q_{I} membrane is shown in the inset (scale: 1 grid square=0.25×0.25 inches). In both the upper and lower plots, the horizontal axis is 2θ (degrees).

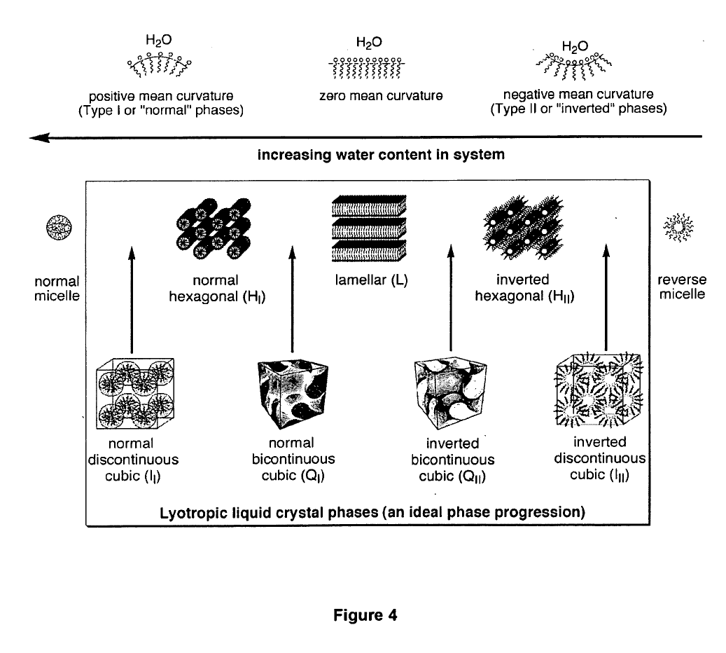

Verification of a Type I structure for the Q phase of Monomer 1. Whether a particular LLC phase is Type I (curves towards the organic domains), or Type II (curves towards water) is usually determined by locating its position on the phase diagram relative to the planar lamellar (L) phase, which has no intrinsic curvature and is considered to be the mid-point of an ideal LLC phase progression Tiddy, G. J. T. Phys. Rep. 1980, 57, 1). As shown in FIG. 4 , Type I LLC phases are located on the water-excessive side of the L phase; and type II phases are located on the water-deficient side of the L phase (Tiddy, 1980). FIG. 4 is a schematic representation of an ideal LLC phase progression as a function of water content in the system. The gray shaded areas are the hydrophobic regions formed by the organic tails of the amphiphiles. The white open regions are the water domains.

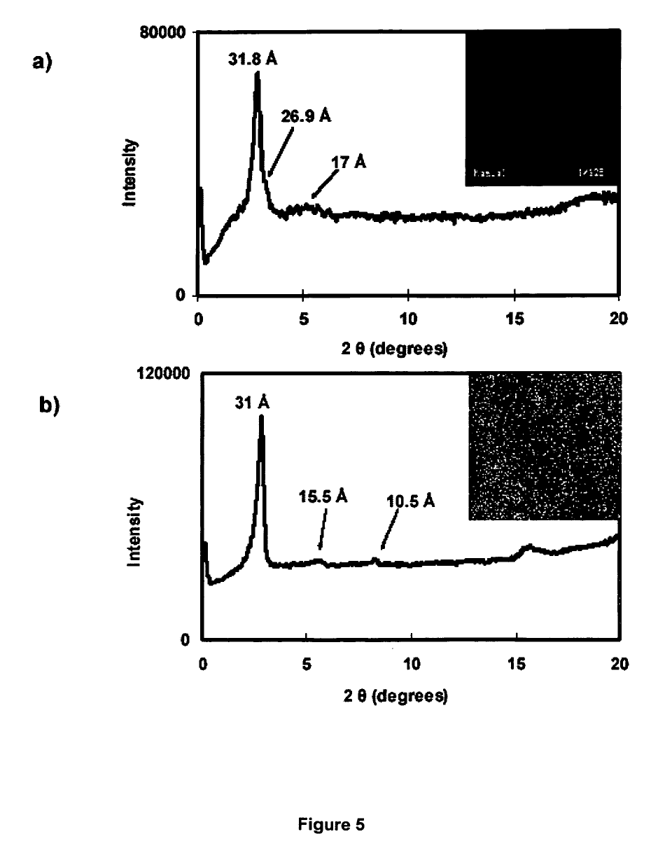

XRD and POM analysis of some of the LLC phases formed by monomer 1 (FIG. 5) shows that monomer 1 forms a L phase with 10 wt % water at 75° C., and a Q phase with 20 wt % water at 65° C. This confirms that the observed Q phase for monomer 1 is located on the water-rich side of the L phase, and thus, a type I Q (Q_{I}) phase is assigned. This data is consistent with previous detailed LLC phase studies confirming a Q_{I} phase for monomer 1 (Pindzola, 2003). The presence of XRD peaks with a d-spacing ratio of 1/√6:1/√8 is consistent with a Q_{I} phase with either a Type I Ia3d or Pn3m structure, both of which are believed to consist of interpenetrating organic networks separated from one another by a continuous, uniform water layer surface with overall cubic symmetry (Pindzola, 2003).

Effect of microporous PE supports with different surface properties on the LLC phase behavior of monomer 1. Two types of microporous films made from fibers of ultrahigh molecular weight polyethyelene (PE) (DSM Solutech) were available as membrane supports in fabricating supported membranes of monomer 1. As shown in Table 1, Solupor® E075-9H01A support is chemically treated to be hydrophilic, and can be fully wetted by water after ca. 1 min. In contrast, Solupor® 14P01E support is also made from ultrahigh molecular weight PE fibers but is hydrophobic and cannot be wetted by water. XRD analysis showed that the Q_{I}-phase structure usually only formed when infused into hydrophilic Solupor® E075-9H01A support. Typical supported membranes of monomer 1 fabricated on hydrophobic Solupor® 14P01E support have no LLC structure by XRD analysis. From FIG. 7, both membranes have over 95% degree of diene photopolymerization by mid-IR analysis.

TABLE 1
Properties of two types of microporous Solupor ® PE supports
and their resulting supported membranes of monomer 1.

| | | Contact | | |
|---|---|---|---|---|
| | Thickness | Angle^{a} | Pure Water Flux | |
| Membranes | (μm) | (degrees) | (L m⁻² h⁻¹ @ 60 psi) | |
| Hydrophilic | 35 | 70 | 90 | |
| Solupor ® E075- | | | | |
| 9H01A PE support | | | | |
| Hydrophobic | 25 | 90 | 157^{b} | (>800 @ 400 psi) |
| Solupor ® 14P01E | | | | |
| PE support | | | | |
| Supported Q_{I} | 40 | 72 | 0.01 | (0.060 @ 400 psi) |
| membrane of | | | | |
| monomer 1 on | | | | |
| Solupor ® E075- | | | | |
| 9H01A support | | | | |
| Supported isotropic | 30 | 55 | 0 | (also 0 @ 400 psi) |

membrane of
monomer 1 on
Solupor ® 14P01E
support

^{a}Contact angles were measured within 30 s when a 2 μL water drop contacts with the membrane surface; and the hydrophilic Solupor ® E075-9H01A support can be fully wetted by water after ca. 1 min;
^{b}Pre-soaked in ethanol before water filtration

Control Experiment Fabrication of supported isotropic membranes of monomer 1. Supported isotropic membranes of cross-linked monomer 1 on Solupor® support were fabricated as controls in the filtration experiments to ascertain the importance of the Q_{I} nanostructure on water transport properties and rejection selectivity. Unfortunately, it was not possible to form supported isotropic membranes of monomer 1 with the same composition on Solupor® E075-9H01A support by heating the hot-pressed LLC monomer gel to the isotropic point and photo-cross-linking the film in the isotropic state. This was because temperatures of >120° C. were needed to form the isotropic melt of the initial Q_{I}-phase monomer gel, and the Solupor® PE support begins to soften and deform at temperatures at 120° C. and above. In order to make an isotropic control sample of a supported membrane of monomer 1, the same procedure used to fabricate supported Q_{I} membranes was applied with the same monomer gel formulation, except that hydrophobic Solupor® 14P01E was used as the support instead. Since monomer 1 was typically unable to form a Q_{I} phase when infused into hydrophobic Solupor® 14P01E, a semi-transparent, supported membrane without LLC structure was achieved. Also, >95% degree of diene polymerization was observed upon radical photopolymerization of these supported isotropic membranes of monomer 1.

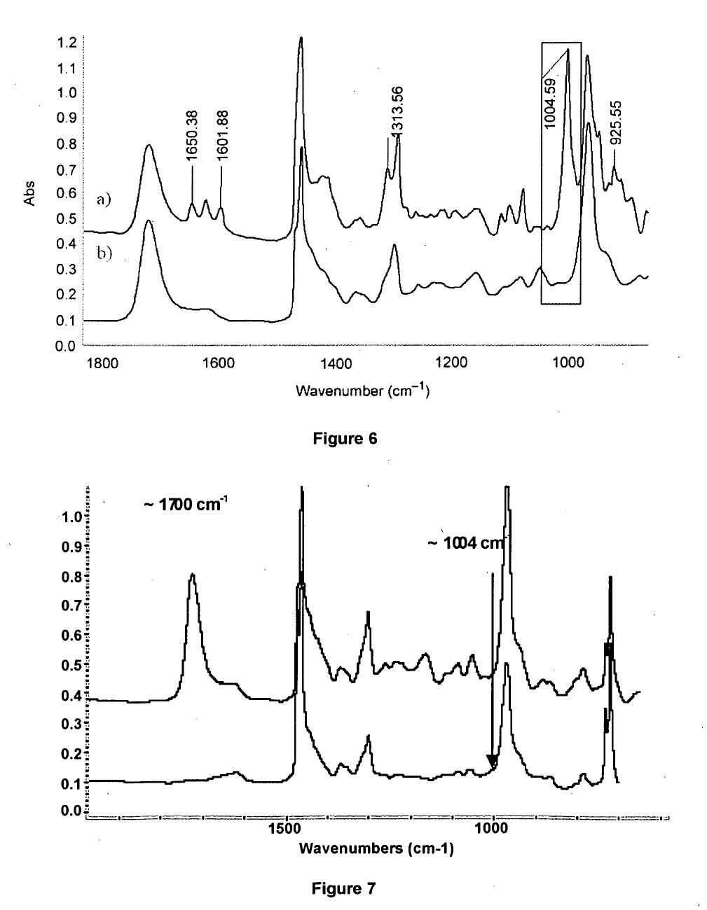

Determination of the degree of diene photopolymerization by mid- (and near-) FT-IR analysis. Both mid-IR and near-IR spectra before and after polymerization were used to determine the degree of diene polymerization. As shown in mid-IR spectra of supported Q_{I} phase membranes (FIG. 6; curve a is before polymerization and curve b is after polymerization), the absorbance peak around 1004 cm⁻¹ coming from the C—H out of plane wagging (Lu, 2006) could be used to quantitatively determine the degree of diene polymerization (The characteristic strong C—H wagging band of the terminal CH₂═CH— unit of ω-alkyl-1,3-diene units is found at 1004 cm⁻¹, based on trans-1,3-pentadiene as a model compound (www.sigmaaldrich.com/spectra/ftir/FTIR000274.PDF). This diene IR band decreases with increasing amounts of 1,4- or 1,2-polymerization). The mid-IR spectrum of the supported membrane before photopolymerization was obtained at 65° C. as the monomer mixture exhibits Q_{I}-phase LLC structure. In addition, the near-IR spectrum of the supported Q_{I} phase membrane has no observable absorbance bands at ca. 6120, 4680, and 4480 cm⁻¹ that are attributed to the C—H bond stretching from the terminal —CH═CH₂ units (Barrow, G. M. Introduction to Molecular Spectroscopy, McGraw-Hill: New York, 1962). This along with the disappearance of the 1004 cm⁻¹ peak in the mid-IR region (Lu, 2006) suggests that the degree of diene photopolymerization for supported Q_{I} membranes are above 95%. FIG. 7 shows the mid-IR spectra of supported membranes. Curve a) shows the results for a hydrophilic support; curve b) for a hydrophobic support.

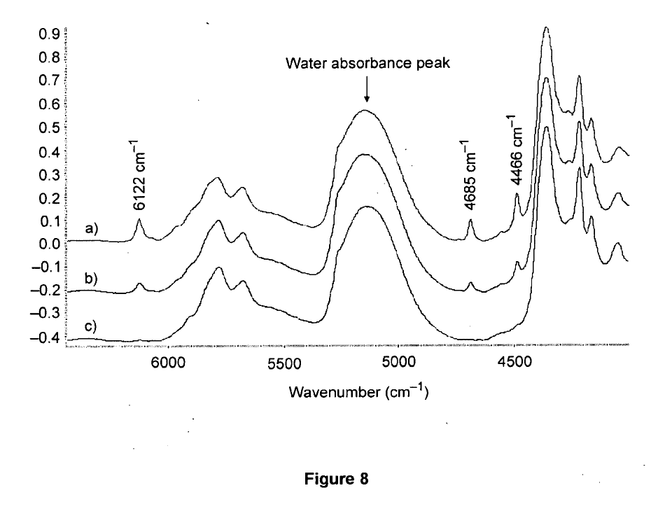

Near-IR studies for determining the relative change in water content upon photopolymerization of supported membranes of monomer 1. In order to monitor the change in water content in the LLC mixture during the polymerization process, near-IR spectroscopy was employed. Water has a distinctive broad absorbance in the near-IR region at ca. 5130 cm⁻¹, which can be used to monitor the variation in water amount during the photopolymerization process (Barrow 1962). FIG. 8 shows the near-IR spectra of a Q_{I}-phase sample of monomer 1 (before, during, and after photopolymerization at 65° C. when hermetically sealed between glass slides with a thin silicone rubber spacer seal around the sample and between the slides to prevent water vapor transfer in the lateral direction. This model system mimics the Mylar sheet and glass plate sandwich configuration used to prevent water loss during hot-pressing and photo-cross-linking at elevated temperature, but eliminates the Mylar peaks during in situ near-IR analysis. As can be seen from FIG. 8, the water peak intensity is essentially unchanged during the photopolymerization process at 65° C. FIG. 8 shows near-IR spectra of a glass-sandwiched and sealed Q_{I}-phase sample of monomer 1 containing 80.0/19.4/0.6 (w/w/w) monomer 1/H₂O/2-hydroxy-2-methylpropiophenone before, during, and after photo-cross-linking at 65° C. The intensity of the water band at ca. 5130 cm⁻¹ remains almost constant, indicating that very little water loss occurs during photopolymerization at elevated temperatures under these conditions

### Example 2

### Filtration Testing of a Composite Membrane Based on a Cross-Linked Bicontinuous Cubic Lyotropic Liquid Crystal Assembly

Table 2 shows the inorganic salt and organic solute rejection performance of supported Q_{I}-phase membranes of monomer 1 (y=6, x=10) obtained using a stainless steel, 25-mm I.D., stirred dead-end filtration cell at 400 psi applied pressure and 2000 ppm aqueous feed solutions. The percent rejections were determined by analyzing the concentration of the solutes in the permeate and retentate using ionic conductivity and/or total organic carbon analysis (see below for a more detailed explanation, values are the avg. of ≧3 independent runs with std. dev. error bars.). The Q_{I}-phase membranes can almost completely (95 to >99.9%) reject dissolved salts (NaCl, MgCl₂, CaCl₂); neutral molecules and macromolecules (glucose, sucrose, PEG-600); and molecular ions (Ethidium Red) in the 0.64-1.2 nm size range in one pass. Only solutes such as ethylene glycol (EG) and glycerol, which are similar in size to water itself, afford mediocre rejections. Based on this performance, the effective “pore” or gap size of the water layer manifold in the Q_{I}-phase network was calculated to be 0.75 nm using the Ferry equation (Aimar, P.; Meireles, M.; Sanchez, V. J. Membr. Sci. 1990, 54, 321, see below.).

TABLE 2
Rejection performance of Q_{I} membranes (dead-end filtration; 400 psi;
0.45-μm pre-filtered 2000 ppm aq. feed solutions; 1 pass).

| | M.W. | Diameter | Rejection |
|---|---|---|---|
| Probe Molecule | (g/mol) | (nm) | (%) |
| Ethidium Red | 378 | 1.2^{a} | >99.9 |
| PEG-600 | 600 | 1.2^{b} | >99.9 |
| sucrose | 342 | 0.94^{c} | >99.9 |
| glucose | 186 | 0.73^{c} | 96 ± 2 |
| glycerol | 92 | 0.36^{d} | 53 ± 1 |
| ethylene glycol | 62 | 0.32^{d} | 38 ± 4 |
| NaCl | 58 | Na⁺_{(aq)}: 0.72; Cl⁻_{(aq)}: 0.66^{e} | 95 ± 1 |
| MgCl₂ | 95 | Mg²⁺_{(aq)}: 0.86^{e} | >99.3 |
| CaCl₂ | 111 | Ca²⁺_{(aq)}: 0.82^{e} | >99.3 |

^{a}MM2 modeling;
^{b}Stokes-Einstein eqn.;
^{c}Bowen, W. R.; Mohammad, A. J.; Hilal, N. J. Membr. Sci. 1997, 126, 91;
^{d}Kosutic, K.; Furac, L; Sipos, L; Kunst, B. Sep. Purif. Technol. 2004, 42, 137;
^{e}Nightingale, Jr., E. R. J. Phys. Chem. 1959, 63, 138.
Values are the avg. of ≧3 independent runs with std. dev. error bars

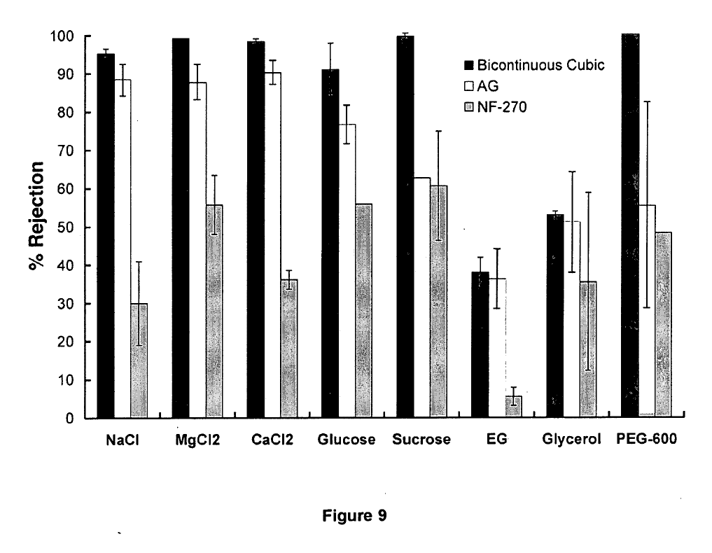

Under the same dead-end filtration conditions (400 psi; 2000 ppm aq. feed solutions), a commercial RO (GE-Osmonics AG) and NF membrane (Dow NF-270) exhibited lower rejections compared to the LLC membrane for the same solutes, except for EG and glycerol (FIG. 9). For glycerol, the three membranes show similar moderate rejections (ca. 40-55%). For EG, the rejections of the LLC and AG membrane are similar (ca. 40%), but NF-270 is much lower.

The thickness-normalized water permeability of the Q_{I}-phase membranes was determined to be 0.089 L m⁻² h⁻¹ bar⁻¹ μm, based on a measured LLC layer thickness of 40 μm. This value is comparable to the reported water permeabilities of commercial RO membranes (0.047-0.28 L m⁻² h⁻¹ bar⁻¹ μm) (Product specifications: www.osmolabstore.com), assuming an active layer thickness of 0.1 μm (which is an upper limit) (Fell, 1995; Ventoza 1985). From measured water fluxes, the permeability of the LLC membrane was found to be slightly lower than that of AG, but both are much lower than that of NF-270 (assuming a 0.1 μm active layer thickness for AG and NF-270, see below.). The Q_{I}-phase membrane also has very stable water filtration performance. Almost full (>95%) water flux recovery after salt solution filtration, and <15% water flux drop upon switching from pure water to various 2000 ppm feed solutions were observed (see below). Control experiments with supported membranes containing an isotropic layer of cross-linked monomer 1 did not show any observable water transport under the same test conditions (see below.). This result confirms that the LLC nanostructure plays an important role in the transport properties of this new water desalination material.

In summary, a new type of nanoporous polymer material capable of efficient water desalination and NF has been demonstrated. This material, which is based on a cross-linked Q_{I}-phase LLC assembly, has an effective pore size of 0.75 nm and is capable of high salt rejection with a water permeability similar to that of commercial RO membranes in dead-end filtration tests.

Instrumentation. Filtration studies were performed using specially designed, stainless steel, stirred, dead-end filtration cells with an internal diameter of 25 mm under N₂ pressure. The ion conductivity of solutions was measured using an OAKTon® ECTestr Conductivity Tester. Total organic carbon (TOC) results for feed and permeate solutions were obtained by employing a customized acid digestion method analyzed using an Agilent 8453 UV-visible spectrophotometer. A COD reactor (DRB 200, HACH®) was used during the TOC digestion step. The thickness of the supported LLC membranes was measured using a handheld Mitutoyo model 293-765-30 micrometer, or a film thickness measurement device from AMES Masters of Measurement Company.

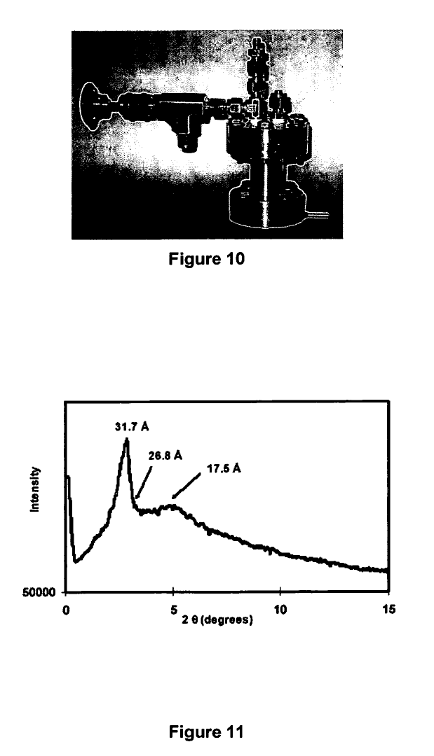

Water NF and desalination testing of supported Q_{I}-phase membranes and commercial RO and NF membranes. Membrane discs 2.5 cm in diameter were punched out from the membrane sheets of Example 1 and soaked in water for 15 min prior to filtration in order to wet the membrane surface. The membrane discs were assembled into a custom-made, stainless steel, stirred, membrane dead-end filtration cell with an inner diameter of 25 mm and an effective filtration area of 3.8 cm² (shown in FIG. 10). Deionized water with a resistivity of >18 MΩ cm⁻¹ was then filtered through the membrane sample under 400 psi applied N₂ pressure with stirring at ambient temperature (21±1° C.) until a steady-state flux was reached. (DI water filtration acts as a control to ascertain the membrane integrity as well as the clean membrane DI water flux.) Then 2000 ppm aqueous feed solutions of the various test substrates in 15 mL of deionized water (pre-filtered through 0.45 μm syringe filters) were then loaded in the cell and used for NF testing. The first 0.8 mL of the permeate was discarded, and the percent rejection was obtained based on the second or third 0.4 mL aliquot of permeate until a constant value was reached. For the organic dye solutions, the percentage rejection were calculated based on the UV-vis absorbance of the permeate vs. that of the retentate. For the inorganic salt solutions, the percent rejection was calculated based on the electrical conductivity of the permeate vs. that of the retentate, which was measured using a conductivity meter. For the neutral organic molecule solutions, a customized total organic carbon (TOC) digestion method was used to quantitatively measure the concentration of neutral organic solutes in the permeate and in the retentate. Calibration plots for all three types of analyses were run with standard feed solutions prior to the studies to ensure accuracy of the measurements.

It should be noted that the observed percent rejections for the commercial AG and NF-270 membranes obtained under the aforementioned dead-end filtration conditions are slightly lower than those given in the on-line product literature for the two membranes. This small difference is most likely due to the fact that different filtration testing conditions were employed (e.g., dead-end vs. cross-flow methods). To ensure the accuracy (and consistency) of our dead-end filtration test results for the commercial AG and NF-270 membranes, the AG and NF-270 samples tested had no visible surface coloration due to aging. Also, secondary tests were performed on freshly acquired samples of the commercial membranes within one week of receipt, and the filtration performance was found to be consistent with that from earlier tests.

Total organic carbon (TOC) analysis. The TOC content in the feed and permeate solutions was obtained by employing a customized acid digestion method, followed by analysis with an Agilent 8453 UV-Vis spectrophotometer. The TOC is measured by monitoring the absorbance of the persulfate-acid digestion of the organic solutions at 600 nm. Commercially available TOC test kits (TOC test N Tube™ Reagent Set) were purchased from HACH®, and the direct method for measuring the TOC content (Method 10128) from HACH® was adopted with slight modifications in determining the TOC content of aqueous solutions. A COD reactor (DRB 200, HACH®) was used.

Control Experiment: Static adsorption testing of organic probe molecules. Prior to the aqueous filtration studies, the static adsorption behavior of the organic probe molecules on the supported Q_{I}-phase membranes was examined. This was done to ensure that the observed rejections with these test substrates was NOT due to chemisorption on LLC material or the Solupor® support. The adsorption of probing molecules on the supported LLC membranes were performed by soaking 2 mg of the supported Q_{I}-phase membrane (pieces) in 1 mL of each probe molecule (0.05 mM dye or 2000 ppm for other solutions), and monitoring the concentration variation of the tested solutions after stirring at room temperature for 24 h. The percent uptake was calculated respectively based on the difference in the intensities of the UV-vis absorbance peaks for the dye molecules, or the TOC content in the initial and final solutions for the neutral organic test molecules after the soaking period, respectively. For all the probe molecules used in the NF studies, ≦5% static uptake was detected on the supported Q_{I}-phase membranes of monomer 1 (see Table 3 below). Therefore, intrinsic adsorption of the substrates onto the membrane does not substantially contribute to the observed retention properties of the membrane. It should also be noted that anionic probe molecules and organic dyes were not tested with the supported LLC membranes because of the possibility of confounding effects due to ion-exchange with the LLC layer from cationic monomer 1.

TABLE 3
Percent static uptakes of organic probe molecules on the supported
Q_{I}-phase LLC membranes (0.05 mM dye solutions, or 2000 ppm for
other solutions; room temperature; 24 h exposure).

| | Static | | Static |
|---|---|---|---|
| Cationic Probe | Uptake | Neutral Probe | Uptake |
| Molecules | (%) | Molecules | (%) |
| Ethidium Red | 0.6 | PEG-600 | 3.8 |
| 10-methyl-9- | 2.4 | sucrose | 1.2 |
| phenylacridinium | | glucose | 4.6 |
| chloride | | glycerol | 2.1 |
| 5-methylphenanthridinium | 2.3 | ethylene glycol | 5.0 |
| iodide | | | |
| 1-methylquinolinium | 1.7 | | |
| iodide | | | |
| 1,4-dimethylpridine | 4.3 | | |
| iodide | | | |

Dead-end filtration percent rejection results for inorganic salts, neutral organic probe molecules, and molecular ions (all effectively non-staining). The percent rejections obtained in a single dead-end filtration pass for various solutes under the test conditions described above are shown in Table 4 below.

TABLE 4
Measured percent rejections of various salt and molecular solutes
of different sizes (dead-end filtration; 400 psi; 0.45-μm
pre-filtered 2000 ppm aqueous feed solutions, one pass).

| | | | Observed |
|---|---|---|---|
| | M.W. | Diameter | Rejection |
| Probe Molecule | (g/mol) | (nm) | (%) |
| Ethidium Red | 378 | 1.2 × 1.1^{a} | >99.9 |
| PEG-600 | 600 | 1.2^{b} | >99.9 |
| Sucrose | 342 | 0.94^{c} | >99.9 |
| Glucose | 186 | 0.73^{c} | 96 ± 2 |
| Glycerol | 92 | 0.36^{d} | 53 ± 1 |
| ethylene glycol | 62 | 0.32^{d} | 38 ± 4 |
| NaCl | 58 | Na⁺_{(aq)}: 0.72; Cl⁻_{(aq)}: 0.66^{e} | 95 ± 1 |
| MgCl₂ | 95 | Mg²⁺_{(aq)}: 0.82^{e} | >99.3 |
| CaCl₂ | 111 | Ca²⁺_{(aq)}: 0.86^{e} | >99.3 |

The values listed are the average values of at least 3 independent sample runs, with standard deviation error bars.
^{a}Calculated using CS Chem3D software employing MM2 force field parameters.
^{b}Calculated using the Stokes-Einstein equation for PEG in water as detailed in reference 6.
^{c}Molecular diameters of glucose and sucrose obtained from Bowen, W. R.; Mohammad, A. J.; Hilal, N. J. Membr. Sci. 1997, 126, 91.
^{d}Molecular diameters of glycerol and ethylene glycol obtained from Kosutic, K.; Furac, L.; Sipos, L.; Kunst, B. Sep. Purif. Technol. 2004, 42, 137.
^{e}Hydrated diameters of atomic ions were obtained from Nightingale, Jr., E. R. J. Phys. Chem. 1959, 63, 138.

The percent rejections of the other non-staining molecular cationic dyes, which are larger than or on par with the size of Ethidium Red (i.e., 10-methyl-9-phenylacridinium chloride, 5-methyl-phenanthridinium iodide, 1-methylquinolinium iodide, and 1,4-dimethylpyridine iodide), were all found to be >99.9%

Control Experiment Filtration testing of supported isotropic membranes of monomer 1. Even though the supported isotropic membranes of monomer 1 formed on Solupor® 14P01E showed a relatively hydrophilic surface, no appreciable water flux was observed at applied pressures of 60 psi or at 400 psi (see Table 6). It should be noted that the blank hydrophobic Solupor® 14P01E support is sufficiently porous that it exhibits a measured pure water flux of ca. 157 L m⁻² h⁻¹ at 60 psi, and >800 L m⁻² h⁻¹ at 400 psi. Consequently, the Solupor® 14P01E support itself cannot be responsible for the lack of water permeation through the isotropic control membranes of monomer 1. In contrast, the supported Q_{I} phase membrane exhibited a water flux of 0.01 L m² h⁻¹ @ 60 psi. This result suggests that the Q_{I}-phase LLC structure is very important to the water transport properties in the LLC membrane.

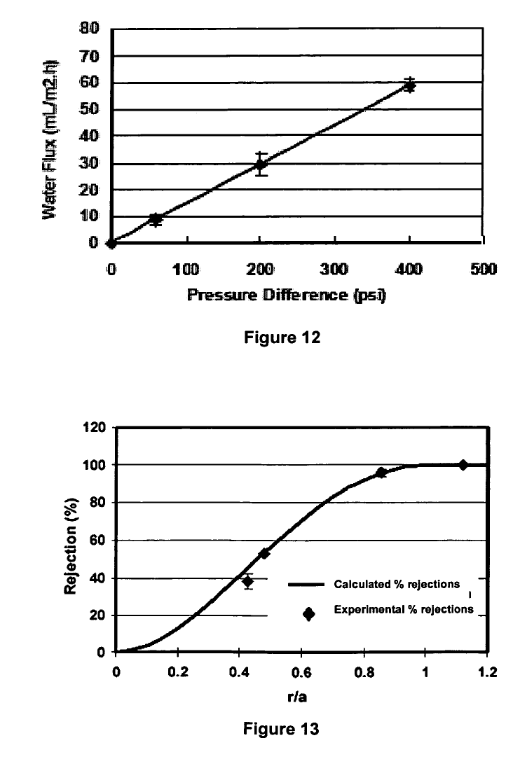

Structural and filtration performance stability of supported, cross-linked Q_{I}-phase membranes of monomer 1. The structural stability of the supported Q_{I} membranes was examined by monitoring the XRD profiles and comparing the d-spacings of the membranes after exposure to different conditions (soaking in water, pressurized filtration, and drying under in vacuo (45 mtorr)). Under all these test conditions, the Q_{I}-phase structure for the supported membrane was maintained (FIG. 11), although there are very slight changes in the position of the first XRD diffraction peak (d₂₁₁) under different testing conditions (Table 5). In addition, the water fluxes were measured at different applied pressures. As shown in FIG. 12, the observed water flux is directly proportional to the applied pressure, which indicates that no significant compaction occurs under these conditions. Furthermore, no appreciable drop in the rejection of salt ions with increasing the volume reduction factor (initial feed volume/final retentate volume) from 1 to 3, was observed.

TABLE 5
XRD structures and position of the first XRD peak for supported
Q_{I} membranes of monomer 1 after several testing regimes.

| | Q_{I} | Position of first Q_{I} |
|---|---|---|
| Supported Membrane Sample | phase | XRD peak, d₂₁₁ (Å)* |
| Freshly prepared membrane | Yes | 32.1 |
| After soaking in water, 24 h | Yes | 33.1 |
| After dynamic vacuum (45 mtorr), 24 h | Yes | 31.4 |
| After aq. filtration at 400 psi, 144 h | Yes | 31.9 |

*XRD profiles were obtained on membrane samples clamped immediately and tightly between Mylar sheets to prevent water loss or water gain after different test procedures. The listed diffraction peaks values were average values of two independent runs.

Estimation of effective “pore” size of supported Q_{I}-phase membranes of monomer 1 using the Ferry equation. The Ferry equation (eqn 1) has been used to correlate the rejection of spherical solutes for membranes with uniform pore size distributions (Zeman, L.; Wales, M. Sep. Sci. Technol. 1981, 16, 275; Aimar, P.; Meireles, M.; Sanchez, V. J. Membr. Sci. 1990, 54, 321). From the observed percent rejections of the essentially non-sorbing neutral organic probe molecules and their estimated diameters (Table 4, upper portion above dashed line), the effective “pore” size of the supported Q_{I}-phase membranes of monomer 1 was calculated to be ca. 0.75 nm by fitting the experimental rejection data (table 4) to an “a” value of 0.75 nm for the effective “pore” diameter (FIG. 13).

R=100×[1−(1−r/a)²]² (eqn. 1)

where R is the percent rejection, r is the solute diameter, and a is the pore size (diameter) of the membrane (assuming a uniform pore size).

FIG. 13 shows calculated and experimentally measured % rejections for the neutral probe molecules of different sizes (upper portion of Table 4). The solid curve represents the calculated % rejections of the neutral organic solutes for a membrane with a uniform pore size (i.e., diameter) (a) of 0.75 nm using the Ferry equation (eqn 1) (Singh, S.; Khulbe, K. C.; Matsuura, T.; Ramamurthy, P. J. Membr. Sci. 1998, Bowen, W. R.; Mohammad, A. J.; Hilal, N. J. Membr. Sci. 1997, 126, 91) The data points (diamonds) represent the experimental % rejection data for the supported Q_{I} membranes. (ΔP: 400 psi, concentration of feed solutions: 2000 ppm).

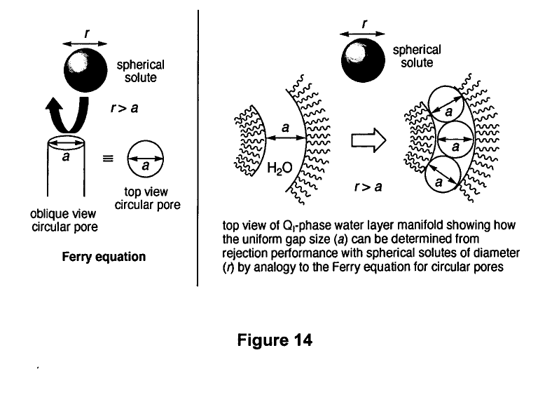

Although the Ferry equation describes the percent rejection (R) expected for a membrane with uniform circular pores of diameter (a) as a function of the diameter of spherical solutes (r), it can also be used by analogy to approximate the effective gap size in the water layer system of our Q_{I}-phase materials. This is because the uniform Q_{I}-phase water layer manifold can be considered be a fusion of adjacent cylindrical circular pores with an effective gap spacing equal to the pore diameter (a) (see FIG. 14 , which shows a model for applying the Ferry equation for rejection performance of membranes with uniform circular pores to a Q_{I}-phase system with a uniform water layer manifold to determine layer gap spacing.). In this analogy, sphericalsolutes of diameter (r) will also be completely size-excluded from a water layer manifold with a gap spacing of (a), if r>a, etc.

Determination of active layer thickness-normalized water permeabilities of the membranes. The active layer thickness-normalized water permeabilities of the supported Q_{I}-phase membranes of monomer 1, AG membrane, and NF-270 membrane were calculated by dividing the observed solution fluxes of the membranes (in units of L m⁻² h⁻¹) by the applied pressure (in bar), and multiplying by the thickness of the active separating layer of the membranes (in μm), since flux is inversely proportional to membrane thickness in general. For the Q_{I}-phase membranes of monomer 1, the active layer thickness was taken to be the thickness of the entire composite membrane (40 μm) as measured by a micrometer because the LLC polymer material is infused completely through the support during hot pressing. Composite RO and NF membranes such as AG and NF-270 have been reported in the literature to have an active top-layer thickness in the 0.05-0.1 μm range (Aimar 1990; Fell 1995). However, the precise active layer thickness of commercial composite RO and NF membranes is very difficult to determine experimentally due to their ultrathin natures (Aimar 1990). Consequently, the active layer thickness of AG and NF-270 was assumed to be 0.1 μm for the permeability calculations, with 0.1 μm being a practical upper limit for active layer thickness and for maximizing water permeability. Using the above formula and assumptions, the thickness- and pressure-normalized pure water permeabilities of the various membranes are listed in Table 6 below. The water permeabilities of prior supported H_{II} membranes formed from sodium 3,4,5-tris(11′-acrylyloxyundecyloxy)benzoate (monomer 2) (Zhou, M.; Kidd, T. J.; Noble, R. D.; Gin. D. L. Adv. Mater. 2005, 17, 1850), and supported isotropic membranes formed from monomer 1, are included for comparison. As expected, the thickness-normalized water permeability of the supported Q_{I} membranes is much larger than that of prior supported H_{II} LLC membranes (Zhou 2005) due to the 3-D interconnected water manifold structure of the Q_{I}-phase materials compared to the 1-D discrete nanochannels of the H_{II} material. In addition, the observed thickness-normalized pure water permeability is comparable to that reported for current commercial RO membranes (Product specifications: www.osmolab.com).

TABLE 6
Comparison of the active layer thickness-normalized water permeabilities
of supported Q_{I} membranes and other membranes. The normalized water
permeabilities of prior supported H_{II} membranes formed from monomer 2,
supported isotropic control membranes formed from monomer 1, and
current commercial RO membranes are included for comparisons.

| | Membrane | | Thickness-normalized |
|---|---|---|---|
| | Active Layer | Water flux | Water Permeability |
| | Thickness | (L m⁻² h⁻¹ | (L m⁻² h⁻¹ |
| Membrane | (μm) | @ 60 psi) | μm bar⁻¹) |
| Supported H_{II} | 30 | 0 | — |
| membrane^{a} of | 1.2 | 0.050 | 0.015 |
| monomer 2 from | | | |
| prior work^{b} | | | |
| Supported Q_{I}-phase | 40 | 0.010 (0.060 | 0.089 |
| membrane of | | @400 psi) | |
| monomer 1^{c} | | | |
| Supported isotropic | 30 | 0 | 0 |
| membrane of 1^{c,d} | | | |
| Commercial RO | <0.1^{e} | — | ca. 0.047-0.28^{f} |
| membranes (dense) | (active layer) | | |

^{a}Pre-soaking in ethanol before assembling into the filtration cell.
^{b}From Zhou 2005.
^{c}Pre-soaking in DI water before assembling into the filtration cell.
^{d}Isotropic control membrane made from hot-pressing and cross-linking of monomer 1 into hydrophobic Solupor ® 14P01E support.
^{e}From Fell, 1995 and Freger, V. Langmuir 2003, 19, 4791
^{f}Product specifications: www.osmolab.com.

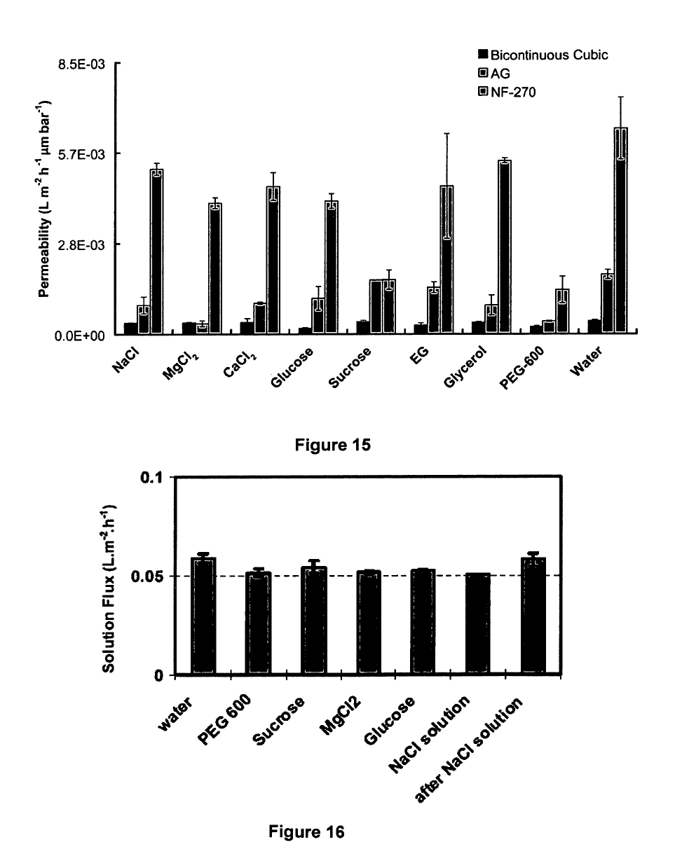

FIG. 15 shows the active layer thickness-normalized solution permeabilities of the Q_{I}, AG, and NF-270 membranes for the various probe solutes (2000 ppm feed solutions) from observed flux data under dead-end testing conditions, using the same calculations and assumptions described above. In particular, FIG. 15 is a comparison of thickness-normalized solution permeabilities of the Q_{I}-phase membrane of monomer 1, AG membrane, and NF-270 membrane based on measured fluxes, applied pressure (400 psi), and active layer thickness. The active layer thickness of the Q_{I} membrane was measured to be 40 μm using a handheld micrometer. The thickness of the active layers of AG and NF-270 were both assumed to be 0.1 μm, which is a practical upper limit (Fell, 1995; Freger, V. Langmuir 2003, 19, 4791). The feed solutions were all 2000 ppm in solute concentration, and pre-filtered through 0.45-μm syringe filters prior to NF testing. The values shown are the average values of at least 3 independent sample runs with standard deviation error bars. For each solute, the data for the bicontinuous cubic membrane is leftmost, the AG data is central, and the NF-270 data is rightmost.

Stability of water filtration performance of supported Q_{I}-phase membranes of monomer 1. As shown in FIG. 16, the observed solution fluxes for 2000 ppm feed solutions of the various probe solutes are all approximately 85% of that of pure water for the supported Q_{I} membranes of monomer 1. In addition, the Q_{I}-phase membranes of monomer 1 show nearly full flux recovery in terms of pure water flux after filtration with 2000 ppm aqueous NaCl solution. This suggests that no substantial adsorption of solute molecules occurs onto the pore walls.

Further details are given in Zhou et al., J. Am. Chem. Soc, 2007, 129(3), 9574-9575, which is hereby incorporated by reference to the extent not inconsistent with the disclosure herein.

### Example 3

### Fabrication of a Cross-Linked Bicontinuous Cubic Lyotropic Liquid Crystal Film

### Synthesis of Monomer 4

### Synthesis of 1,1′-(oxydi-2,1-ethanediyl)bisimidazole

This compound was prepared by a method similar to that described by Bara et al. (Bara, J. et al., J. Membrane Sci, 316 (2008), 186-191): A 500-mL 3-neck, round-bottom flask equipped with stir bar and reflux condenser was purged (while hot) 3 times by alternating vacuum and argon flush cycles. NaH (14.7 g, 368 mmol, 60 wt % in mineral oil) was added to the vessel. Anhydrous THF (250 mL) was added to the flask, and the mixture slurried. Imidazole (20.0 g, 294 mmol) was added slowly, while H₂ gas evolved as a consequence of the neutralization reaction. The reaction was stirred at room temperature until gas bubbles were no longer visible. α,ω-oligo(ethylene glycol) ditosylate (147 mmol) was added via syringe. The reaction was sealed under argon and heated at reflux (65° C.) overnight. After this time, the solids were filtered and washed with THF. The filtrate was reduced via rotary evaporation, then MeOH (250 mL) was added. The MeOH phase was washed with hexanes (3×125 mL) and the solvent removed via rotary evaporation. The product was dried under vacuum overnight to produce an off-white, waxy solid.

To a flame-dried air free round bottomed flask charged with a stir bar and acetonitrile (20 mL) was added 1,1′-(oxydi-2,1-ethanediyl)bisimidazole (0.344 g, 1.664 mmol, 100 mol %) and 14-bromotetradeca-1,3-diene (1.000 g, 3.66 mmol, 220 mol %). The 14-bromotetradeca-1,3-diene was prepared by the method described by Hoag et al. (Hoag, B. et al, Macromolecules, 2000, 33, 8549-8558). The clear colorless solution was stirred under Ar at reflux for 20 h. The flask was cooled and the acetonitrile was evaporated under reduced pressure (25 mm Hg). The crude white solid was washed with hexanes (40 mL) and filtered to give the product as a white solid (1.409 g, 99%). ¹H NMR (400 MHz, DMSO-d₆) δ 1.21 (m, 32H), 1.75 (sextet, 4H), 2.05 (q, 4H), 3.78 (d, 4H), 4.17 (t, 4H), 4.36 (t, 4H), 4.95 (dd, 2H), 5.08 (dd, 2H), 5.71 (m, 2H), 6.03 (m, 2H), 6.29 (m, 2H), 7.73 (d, 2H), 7.80 (t, 2H), 9.24 (s, 2H); ¹³C NMR (100 MHz, DMSO-d₆) δ 25.5, 28.4, 28.62, 28.64, 28.8, 28.9, 29.4, 31.9, 48.6, 48.7, 68.0, 115.1, 122.1, 122.8, 130.8, 135.2, 136.3, 137.2; IR (thin film on Ge, MeOH) υ 2924, 2853, 2360, 2344, 1700, 1652, 1559, 1557, 1464, 1456, 1165, 1001 cm⁻¹; HRMS (MS/MS) Calcd. for C₃₈H₆₄⁸¹BrN₄O⁺:673.4295 Observed: 673.4245

Q_{I}-Phase Formation/Mixing with Monomer 4

12.5 mg (0.0157 mmole) of monomer 4 was placed into a custom glass microtube (8 mm ID×30 mm length). 50% (w/w) (13.04 μL) of distilled water (˜1.6 MΩ electrical resistance) was added via mechanical pipet. 1% (w/w) of 2 hydroxy-2-methoxy-propiophenone (F.W. 164.20, Aldrich), a radical photo-initiator, was then added Sample was covered with Parafilm™ to minimize water loss via evaporation, and placed into a Centra CL2 centrifuge. The room temperature samples were spun at 3800 rpm for 30 min followed by hand mixing for 3 min. This cycle was repeated for a total of 3 mixing cycles to ensure sample homogeneity of the achieved LLC phase. Formation of the Q_{I} LLC phase was confirmed by XRD analysis (XRD peaks with a d-spacing ratio of 1/√6:1/√8, etc.), the presence of a viscous, optically transparent sample under normal light, and a black optical texture when observed under polarized light microscopy (crossed polarizers) (Pindzola, 2003).

### Formation and Photo-Cross-Linking of Films of the Q_{I} Phase of Monomer 4

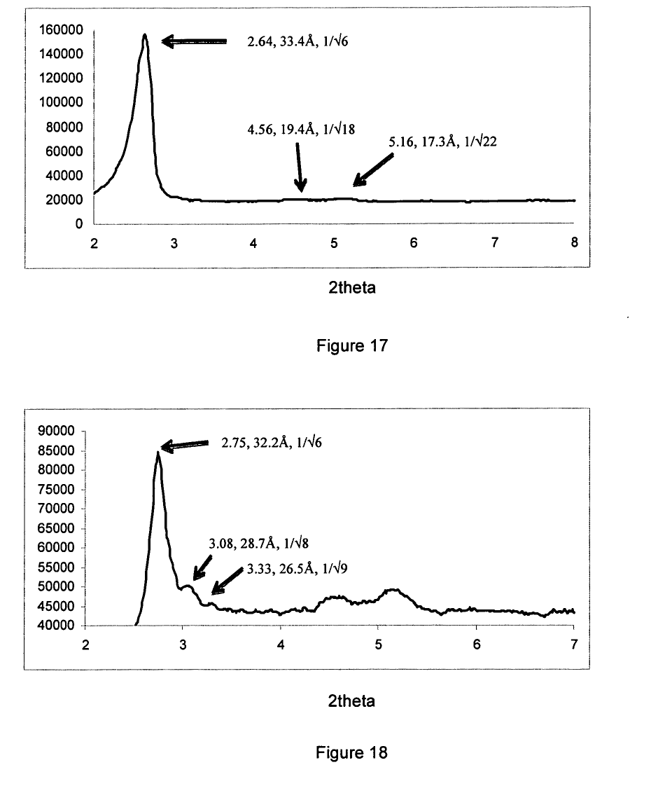

An optically transparent sample of the pre-formed Q_{I}-phase monomer/water/photoinitiator gel was deposited onto a clean quartz glass plate. A second quartz plate was then placed on top of the first plate and clamped closed compressing the sample between to spread it out and form a film (pressure approximately 20-50 psi). The sample was then irradiated with a Spectraline UV Lamp (365 nm, 370 μW/cm²) for approximately 90 minutes at room temperature to induce polymerization. Plates were opened and the film removed from the quartz surface. The degree of 1,3-diene polymerization was determined by quantitative FT-IR analysis in absorbance mode, as described in the literature (Pindzola 2003, Hoag, 2000). Retention of the Q_{I} LLC phase was confirmed by XRD analysis (XRD peaks with a d-spacing ratio of 1/√6:1/√8, etc.) and a black optical texture when observed under polarized light microscopy (crossed polarizers) (Pindzola, 2003). FIG. 17 shows an XRD plot of intensity versus 2theta, indicating the peaks at 1/sqrt(18) and 1/sqrt(22). From left to right, the peaks shown are 2theta=2.64 (33.4 Å), 4.56 (19.4 Å), and 5.16 (17.3 Å). FIG. 18 shows an XRD plot of intensity v. 2theta, indicating that the peaks at 1/sqrt(8) and 1/sqrt(9). From left to right, the peaks shown are 2theta=2.76 (32.2 Å), 3.08 (28.7 Å), and 3.33 (26.5 Å). Table 7 compares the measured peak positions to their theoretical values.

TABLE 7
Comparison of observed XRD and theoretical XRD peaks
for the cross-linked Q_{I} phase of monomer 4.

| | Observed | Theoretical |
|---|---|---|
| Peak | 2theta | 2theta |
| 1/√18 | 4.56 | 4.57 |
| 1/√22 | 5.16 | 5.06 |
| 1/√8 | 3.08 | 3.18 |
| 1/√9 | 3.33 | 3.37 |

We claim:

1. A composite nanofiltration membrane comprising: a porous support and a porous lyotropic liquid crystal (LLC) polymer composition attached to the support, the LLC polymer composition formed by polymerization of an LLC mixture which forms the type I bicontinuous cubic LLC phase, the LLC mixture comprising a plurality of polymerizable LLC monomers and an aqueous or polar solvent and not including a hydrophobic polymer, the LLC polymer composition comprising a pore structure of interconnected nanopores based on the type I bicontinuous cubic LLC structure and having an effective pore size from 0.5 to 5 nanometers.

2. The composite membrane of claim 1, wherein the porous LLC polymer composition is embedded within the support.

3. The composite membrane of claim 1, wherein the porous LLC polymer composition forms a layer on the surface of the support.

4. The composite membrane of claim 1, wherein the effective pore size of the LLC polymer composition is less than 2 nm.

5. The composite membrane of claim 4, wherein the effective pore size of the LLC polymer composition is less than 1 nm.

6. The composition membrane of claim 1, wherein the solvent is aqueous.

7. The composite membrane of claim 5, wherein the membrane is capable of rejecting greater than 90% of NaCl in aqueous solution.

8. The composite membrane of claim 6, wherein the membrane is capable of rejecting greater than 94% of NaCl in aqueous solution.

9. The composite membrane of claim 1 wherein the composite membrane has a water permeability of greater than 0.08 Lm⁻² h⁻¹ bar⁻¹ μm.

10. The composite membrane of claim 1, wherein the porous support is hydrophilic.

11. The composite membrane of claim 1, wherein the pore size of the support is 0.1 μm to 10 μm.

12. The composite membrane of claim 1, wherein the LLC polymer composition comprises polymerized gemini surfactant monomers.

13. The composite membrane of claim 1, wherein the LLC mixture comprises polymerizable monomers of the structure: 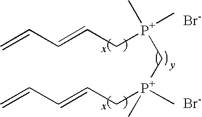
where x is 8, 10 or 14 and y is 2, 4 or 6.

14. The composite membrane of claim 1, wherein the LLC polymer mixture comprises polymerizable monomers of the structure: 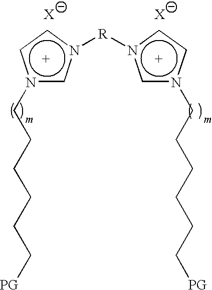
where X is a anion, R is (CH₂)ₓ, where x is from 1 to 12 or ((CH₂)₂O)_{y}(CH₂)₂ where y is from 1 to 6, PG is a polymerizable group, and m is from 0 to 10.

15. The composite membrane of claim 14, wherein X is selected from the group consisting of a halide anion, a triflate anion, a alkyl sulfonate anion, a dicyanamide anion, a methyl sulfonate anion, or BF⁴⁻

16. The composite membrane of claim 15, wherein X is halide, R is ((CH₂)₂O)_{y}(CH₂)₂ where y is 1, m is 5 and PG is

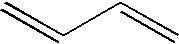

17. A method for making a composite membrane comprising an porous support and a porous LLC polymer composition embedded within the support, the method comprising the steps of:
providing the support;
preparing a LLC mixture comprising a plurality of polymerizable LLC monomers , a polymerization initiator and an aqueous or polar solvent, but not including a hydrophobic polymer, wherein at least some of the LLC monomers assemble to form a type I bicontinuous cubic LLC phase;
impregnating the support with the LLC mixture; and
cross-linking at least some of the LLC monomers,
wherein the type I bicontinuous cubic LLC phase is substantially maintained during impregnation and cross-linking.

18. The method of claim 17 wherein the support is impregnated with the LLC mixture by application of heat and pressure.

19. The method of claim 17, wherein the support is hydrophilic.

20. The method of claim 17 wherein the pore size of the support is from 0.5 μm to 10 μm.

21. The method of claim 17, wherein the degree of cross-linking is greater than 90%.

22. The method of claim 17, wherein the LLC mixture comprises polymerizable monomers of the structure: 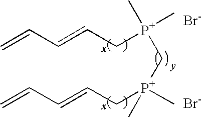
where x is 8, 10 or 14 and y is 2, 4 or 6.

23. A method for making a composite membrane comprising a porous support and a porous LLC polymer composition forming a layer on the surface of the support, the method comprising the steps of:
a. providing the porous support;
b. preparing a LLC mixture comprising a plurality of polymerizable LLC monomers , a polymerization initiator and an aqueous or polar solvent, but not including a hydrophobic polymer, wherein at least some of the LLC monomers assemble to form a type I bicontinuous cubic LLC phase;
c. applying a layer of the LLC mixture onto the support; and
d. cross-linking at least some of the LLC monomers,
wherein the type I continuous cubic LLC phase is substantially maintained during impregnation and cross-linking.

24. The composite membrane of claim 23, wherein the LLC mixture comprises polymerizable gemini surfactant monomers.

25. The method of claim 23, wherein the LLC monomers have the chemical structure 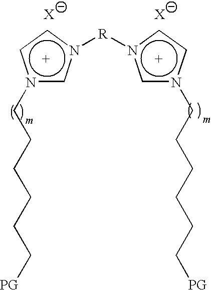
where X is a anion, R is (CH₂)ₓ where x is from 1 to 12 or ((CH₂)₂O)_{y}(CH₂)₂ where y is from 1 to 6, PG is a polymerizable group, and m is from 0 to 10

26. A process for separating a component of a first fluid mixture, comprising the steps of:
bringing said first fluid mixture into contact with the inlet side of a composite membrane of claim 1;
applying a pressure difference across said composite membrane; and
withdrawing from the outlet side of said composite membrane a second fluid mixture, wherein the proportion of said component is depleted, compared with said first fluid mixture.

27. The process of claim 26, wherein the effective pore size of said composite membrane is smaller than the molecular size of said component.
